(19) United States
(12) Patent Application Publication
(10) Pub. No.: US 2025/0139183 A1
(43) Pub. Date: May 1, 2025

(54) LOCATION-BASED SYSTEM AND METHOD FOR SEARCHING AND ACCESSING BANNED WORKS

(71) Applicant: MORGEN REE THOMPSON, GERMANTOWN, MD (US)

(72) Inventor: MORGEN REE THOMPSON, GERMANTOWN, MD (US)

(21) Appl. No.: 18/495,617

(22) Filed: Oct. 26, 2023

(51) Int. Cl. G06F 16/9537; G06F 16/9538

(52) U.S. Cl. CPC G06F 16/9537; G06F 16/9538

(57) ABSTRACT

Systems and methods for searching and accessing banned works include a client device for interaction through either a web-based or mobile application. The systems and methods facilitate user selection of predetermined search criteria for the banned works, including location-based search criteria and automatic geolocation search criteria. A search engine processes search results and generates matching search results based on the predetermined search criteria. A mapping module maps banned work data to a plurality of data points from one or more databases containing information about the banned works and their associated locations based on the predetermined search criteria. The mapping process incorporates geospatial coordinates for the location-based search criteria and user-specific geolocation data for the automatic geolocation search criteria. Users are provided with location-specific banned works, comprehensive information about the works, and details about their associated locations, enabling them to explore works that have been challenged or censored in various contexts.

### TECHNICAL FIELD

The present disclosure generally relates to location-based systems and methodologies, specifically focusing on the integration of geolocation technology, for delivering location-specific and targeted search results for banned works and their associated locations. Even more particularly, the location-based systems and methodologies utilize geospatial coordinates and user-specific geolocation data to provide users with search results, including comprehensive information about banned works and details regarding their associated locations, tailored to their real-time geographical context.

### BACKGROUND

The background description provided herein is for the purpose of generally presenting the context of the disclosure.

Existing digital systems enable users to search for books through keyword-based methods or manual categorization while neglecting the importance of geographic context. While these systems help users identify books, they lack integration with geolocation technology in a location-based system and the ability to tailor search results to a user's immediate physical proximity, within defined geographic areas of interest, or at specific points of interest. This omission often leads to the absence of contextual relevance for a user's specific county, city, or district, which can vary based on a user's geographic context. Accordingly, the scarcity of targeted information can inadvertently lead to violations of county or city regulations or educational institution policies regarding banned content, potentially resulting in legal and academic consequences. Moreover, navigating through an excessive number of search results that may not align with a user's geographic context is inefficient and time-consuming, ultimately undermining the efficient utilization of time resources.

The existing systems lack a comprehensive and diverse array of works encompassing creative or intellectual content prohibited or banned from publication, distribution, display, or access. Data related to censored books is scattered across fragmented sources, ranging from manual spreadsheets to decentralized databases, resulting in disparities, obsolete information, and complexities in maintaining a comprehensive and accurate repository of censored books. Additionally, some censored books can be accessible only to select privileged audiences or distributed underground to circumvent censorship.

The existing systems lack comprehensive information in their non-location-specific search results. Although certain systems may furnish rudimentary particulars concerning books, such as titles and authors, they fail to deliver exhaustive details about the grounds for banning, historical and cultural significance, authoritative legal and administrative decisions, and any other relevant or comprehensive information that would help users understand banned works in a broader context. Such constraint curtails the user's capacity to grasp the complete significance and repercussions of banned works and to differentiate between works legally prohibited and those merely engendering controversy or subject to restriction.

The existing systems do not possess the capability to assist users in locating banned works closely aligned with their physical proximity, within a defined geographic area of interest, or at a specific point of interest. Consequently, these current systems fail to account for the unique financial and physical constraints users may encounter while attempting to access banned works, thereby placing a significant disadvantage on individuals with limited financial resources who cannot afford to purchase such materials and neglecting the challenges faced by people with disabilities who may struggle to travel to distant locations to acquire banned works. The absence of geographic context in these systems disproportionately hampers the ability of marginalized groups to access banned works that cater to their specific limitations, further exacerbating their disadvantage.

As such, a need may exist for an efficient and dependable solution that enables users to search, access, comprehend, and locate banned works within their immediate geographic location, a defined geographic area of interest, or at a specific point of interest.

### SUMMARY

This section provides a general summary of the disclosure and is not a comprehensive disclosure of its full scope or all of its features.

According to one example embodiment, the location-based system searches and accesses a diverse array of banned works, such as books, literature, performing arts, visual arts, video games, symbols, educational courses, products, and services. The system includes a client device for interaction through a web-based or mobile application that facilitates user input and selections related to banned works. A search engine processes search results and generates matching search results based on predetermined search criteria. A mapping module maps banned work data to a plurality of data points from a database containing information about the banned works and their associated locations based on the predetermined search criteria. Users are presented with location-specific banned works, comprehensive information about the works, and details about their associated locations.

According to another example embodiment, the location-based system utilizes geocoding to determine geospatial coordinates of a geographical area of interest or point of interest, and geolocation technology to determine user-specific geolocation data of a person or device. Geocoding is the process of converting textual location-based information into geospatial coordinates, typically including latitude and longitude values. Users provide location-based information in text form, and the location-based system uses geocoding services to translate this information into precise geospatial coordinates. Geolocation is the process of determining the real-time geographic location of a person or device by leveraging signals from satellites, cell towers, Wi-Fi access points, or other sources to calculate latitude and longitude coordinates. Users opt to share their real-time Global Positioning System (GPS) coordinates, enabling geolocation to pinpoint their precise physical location. The location-based system utilizes geospatial coordinates and user-specific geolocation data to generate location-specific and targeted search results for banned works and their associated locations.

According to another example embodiment, the location-based system utilizes one or more databases or a plurality of interconnected databases that comprehensively and systematically catalog banned works from various sources. The databases contribute to the system's functionality and can contain diverse information, including comprehensive information, associated location data, and other data. They may be public, private, or a combination thereof. The comprehensive information includes details about the banned works, such as titles, descriptions, creators, biographies, additional creator works, recommended works, publication dates, reasons for the ban, relevant historical and cultural context, authoritative legal and administrative decisions, and other relevant information. It enhances the user's experience based on their specific interests.

According to another example embodiment, the location-based system utilizes geolocation technology to map banned works to nearby venues, including private libraries, public libraries, university libraries, digital libraries, and online platforms. The mapping module integrates data related to banned works with geolocation technology, generating user-specific search results focused on the availability and physical location of the banned works. Users can easily find the nearest venues offering the banned works through a map interface.

Further areas of applicability and various methods of enhancing the above technology will become apparent from the description provided herein. The description and specific examples in this summary are intended for purposes of illustration only and are not intended to limit the scope of the present disclosure.

### BRIEF DESCRIPTION OF THE DRAWINGS

The details of one or more implementations are set forth in the accompanying drawings and the description below. Other features, aspects, and advantages of the disclosure will become apparent from the drawings, descriptions, and claims, in which:

FIG. 1 is a block diagram of a location-based system for searching and accessing banned works according to an example embodiment.

FIGS. 2A and 2B are block diagrams of client devices of the location-based system in FIG. 1 according to example embodiments.

FIG. 3A is a block diagram of the high-performance server of the location-based system in FIG. 1 according to an example embodiment.

FIG. 3B is a block diagram of the search engine module of the high-performance server according to an example embodiment.

FIG. 4 is a block diagram of the database of the location-based system in FIG. 1 according to an example embodiment.

FIGS. 5A and 5B are block diagrams of mapping modules of the location-based system in FIG. 1 according to example embodiments.

FIG. 6 depicts a process of searching for banned works that may be implemented by the system in FIG. 1 according to an example embodiment.

FIGS. 7A through 7E illustrate display screens that may be displayed to the user during the process in FIG. 6.

FIG. 8 depicts the process of accessing comprehensive information about a banned work selected from search results that may be implemented by the system in FIG. 1 according to an example embodiment.

FIGS. 9A and 9B illustrate display screens that may be displayed to the user during the process in FIG. 8.

FIG. 10 depicts a process of retrieving locations of banned works that may be implemented by the system in FIG. 1 according to an example embodiment.

FIG. 11 illustrates a display screen that may be displayed to the user during the process in FIG. 10.

It should be noted that the figures set forth herein are intended to exemplify the general characteristics of the methods, algorithms, and devices among those of the present technology for the purpose of the description of certain aspects. These figures may not precisely reflect the characteristics of any given aspect and are not necessarily intended to define or limit specific embodiments within the scope of this technology. Further, certain aspects may incorporate features from a combination of figures.

### DESCRIPTION

The figures and accompanying descriptions provide an overview of the features and functionalities presented. These figures and descriptions should not be considered limiting, as various modifications and adaptations can be made within the scope of the disclosure. The phraseology and terminology used in the disclosure and referenced herein should not be regarded as limiting.

Referring generally to the figures, the present teachings pertain to location-based systems and methodologies for delivering location-specific and targeted search results for banned works. Banned works refer to artistic, literary, or creative creations that have been officially prohibited or restricted by a governing authority, institution, or organization. These bans are often implemented due to various reasons, including cultural, political, religious, moral, or social considerations. Banned works can range from controversial content to materials deemed offensive, subversive, or dangerous according to the standards of the censoring entity. The goal of banning such works is typically to prevent their distribution, exhibition, or dissemination to control or limit their influence on the public.

In an embodiment of the present disclosure, a digital platform effectively addresses critical challenges, including the lack of awareness and difficulties individuals face in locating banned works, limited access to diverse perspectives and intellectual freedom, and the need for comprehensive resources providing information about banned works, their availability, and contextual details. By delivering search results tailored to users' geographic context and preferences, the platform ensures that individuals are not only aware of banned works but also equipped with the knowledge needed for meaningful and informed engagement, thereby enabling them to gain insight from banned works that have been challenged or censored in various contexts.

In various embodiments, individuals have multiple ways to interact with the location-based system to search and access banned works. They can choose search criteria, enter search queries, view search results and locations, apply filters, and interact with the features of the location-based system. The search criteria can include a location-based search and an automatic geolocation search. The location-based search enables users to search for banned works within a defined geographic area of interest or at a specific point of interest. The location-based search returns targeted search results within the defined geographic area of interest or at the specific point of interest. The automatic geolocation search enables users to search for banned works based solely on the user's or device's current geographical position. The automatic geolocation search returns targeted search results based on the user's real-time geographical position. Users can enter search queries (e.g., radius distance, terms, titles, creators) and select either the location-based search or automatic geolocation search criteria to make search results more relevant and tailored to the user's specific preferences or requirements. In some embodiments, a default preset radius can be set in the location-based system to ensure that search results are targeted to the user's location, geographical areas of interest, or points of interest. In other embodiments, users can adjust or remove the default preset radius within individual user profiles within the location-based system 100. Once the search results are presented to the user based on their search criteria and queries, the user can view comprehensive information about the banned works and their associated locations, apply filters (e.g., thematic elements, genre/categories, other attributes) to refine and narrow down their search results, and interact with a map interface and other system functionalities. Terms can serve dual roles, functioning both as search queries for broad topic-related results and as filter categories to refine results based on specific aspects of interest or boundaries without limitations.

While the present disclosure prominently features banned works, its applicability extends beyond this domain. It finds utility in diverse environments and caters to a myriad of purposes and needs that can leverage the capabilities of location-based searches and automatic geolocation searches. The pertinent data should be contained within or accessible by the location-based system described in the present disclosure.

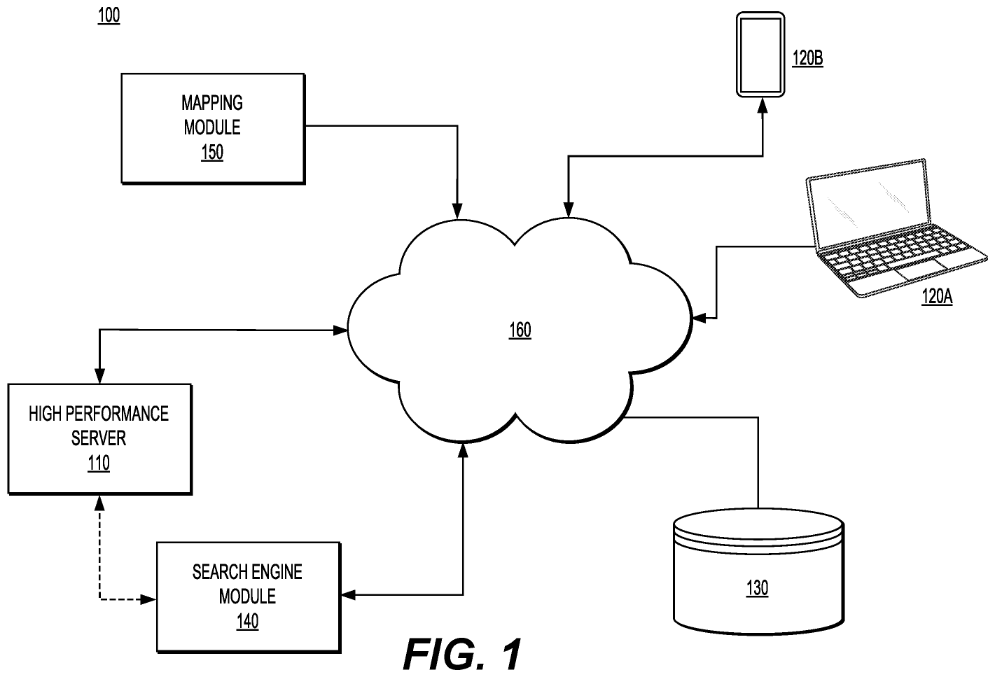

FIG. 1 illustrates the architecture, data synchronization, and data flow between system components of the location-based system 100. According to one example embodiment, the location-based system 100 may include system components including a high-performance server 110, client device 120, database 130, search engine module 140, and mapping module 150. The location-based system 100 can be an internet-based system, a mobile application-based system, or other types of location-based systems. The internet-based system can offer wider accessibility as users can access it through various devices with internet connectivity. The mobile application-based system can provide a more seamless and immersive user experience for those who prefer using dedicated mobile applications.

Referring to FIG. 1, a network infrastructure 160 enables seamless connectivity and communication among the system components of the location-based system 100. In various embodiments, the different system components can establish communication and transmit data using a robust and secure external network infrastructure. The network infrastructure 160 can encompass a range of wired or wireless networks, such as the internet, cellular network, Wi-Fi, ethernet, fiber optics, satellite network, and other similar technologies. Through the network infrastructure 160, the system components are interconnected with the broader internet. In other embodiments, the network infrastructure 160 can be part of the connectivity options of the client device 120. The location-based system 100 can utilize the network connectivity capabilities of the client device 120, including technologies such as Wi-Fi, cellular networks, and other available networks. In other embodiments, the network infrastructure 160 can be intrinsic to the client device 120 rather than being a separate, explicitly integrated component within the location-based system 100.

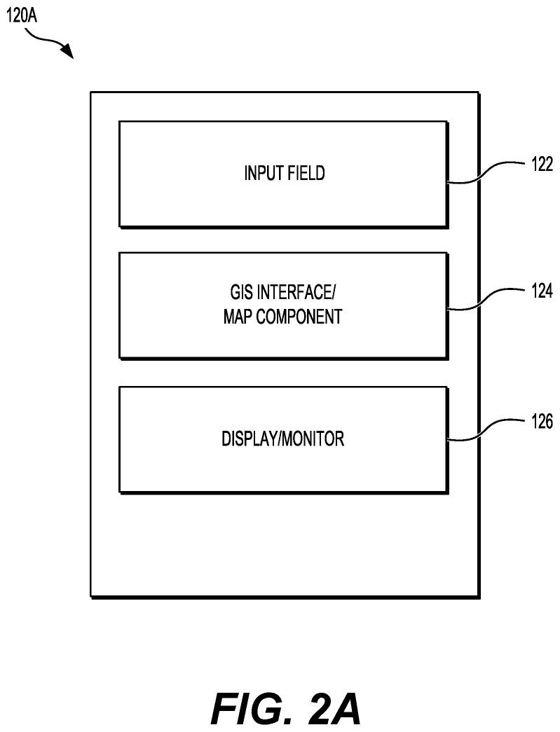

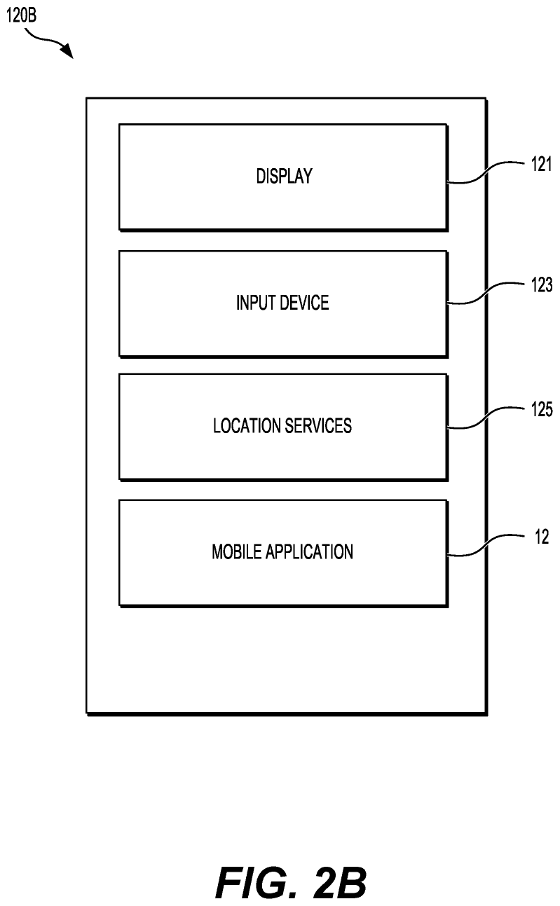

In some embodiments, the client device 120, such as computers and tablets equipped with web browsers, serves as the interface (e.g., web-based interface) through which users interact with the location-based system 100. They can determine user locations through methods such as Internet Protocol (IP) based geolocation and user-provided information since such devices typically lack built-in GPS hardware. Referring now to FIG. 2A, the client device 120 can contain a user interface 120A through which the user interacts with the location-based system 100 using a web browser or other suitable client software on the client device 120. The user interface 120A can include an input field 122, a graphical interface/map component 124, and a display/monitor 126. The input field 122 enables users to select search criteria, enter search queries, apply filters, and interact with the features of the location-based system 100. The graphical interface/map component 124 enables users to interact with interactive maps and geographic information systems visually representing the positions or locations (e.g., markers, pins) of banned works. The display/monitor 126, a visual interface for presenting information, enables users to view search results and other information, such as comprehensive information about the banned works and their associated locations. In some embodiments, the interaction between the graphical interface/map component 124 and display/monitor 126 can support navigation and give users directions to the physical locations where the banned works are available. Additional functionality of the user interface 120A can include filters, sorting, user profiles, and settings. The filters and sorting options enable users to refine their search results based on additional criteria, such as language, thematic elements, or genre/categories. The user profiles and settings enable users to personalize their preferences and manage their account information, including adjusting or removing the default preset radius within their individual user profiles.

In alternative embodiments, the client device 120, such as a mobile device, smartphone, or computer connected to the internet, serves as the interface through which users interact with the location-based system 100. It can contain hardware components, such as GPS receivers, and software interfaces that determine the user or device's location. Referring to FIG. 2B, the client device 120 can be a user device 120B with a dedicated interface that facilitates selecting search criteria, entering search queries, applying filters, viewing search results, and interacting and accessing the features of the location-based system 100. The user device 120B can include a display 121, input device 123, location services 125, and client or mobile application 12. The display 121 can present a visual interface that enables users to navigate through different screens of the mobile application 12. The input device 123 can include touchscreens, buttons, and keyboards, enabling users to interact seamlessly with the mobile application 12. The mobile application 12 is the software that runs on the user device 120B. It can leverage the location services 125, such as GPS, Wi-Fi positioning, and cellular network data, to provide accurate geolocation information for locating banned works within the vicinity of the user.

The mobile application 12 handles processing and functionality on the user device 120B. A search engine module 140 and mapping module 150 can be integrated directly within the mobile application 12, operating in tandem with the user device 120B to facilitate searches and mapping of banned works data based on geospatial coordinates, user-specific geolocation data, or other relevant data. The mobile application 12 can include a mobile application server component, which acts as the intermediary between the mobile application 12 and the server-side components. The mobile application server component oversees communication, data transmission, and synchronization between the mobile application 12 and the integrated search engine module 140 and mapping module 150, ensuring seamless integration and interaction. In other embodiments, the mobile application 12 can include a notification module equipped with push notification services, enabling real-time notifications and updates to be sent directly to the mobile application 12 that are tailored to the user's preferences. These notifications may cover a range of topics, such as newly available banned works in the user's specified geographic area, updates on existing banned works, alerts when a desired banned work is nearby, system enhancements, and community-related activities. The real-time updates enrich the user experience, ensuring they stay engaged with the location-based system 100 and its content.

In yet other embodiments, the client device 120 can support multiple languages, enabling users to interact with the location-based system 100 in their preferred language and adhere to accessibility guidelines, ensuring accessibility for visual or hearing impairments. The client device 120 can employ internationalization techniques, such as language resource files and localization frameworks, to facilitate seamless translation and adaptation of the user interface elements. It can adhere to industry-standard accessibility guidelines, such as Web Content Accessibility Guidelines, to accommodate users with varying disabilities, including sensory, intellectual, learning, and physical disabilities. The client device 120 can incorporate features such as keyboard navigation support, alternative text for images, and compatibility with screen readers. It can provide options for adjusting text size, contrast, and other visual settings.

The network infrastructure 160 establishes robust connections and communications between the client device 120 and other system components, including the high-performance server 110 or search engine module 140, and the database 130. This ensures requests are reliably and securely transmitted and data is efficiently delivered back to the client device 120. The network infrastructure 160 facilitates the communication between the location-based system 100 and external geocoding services. It manages the data exchange, sending the user's location-based inputs including radius distances to the geocoding service and receiving the corresponding geospatial coordinates. It also helps facilitate geolocation by providing communication channels for the client device 120 to interact with various signals and services, including GPS satellites and cell towers. It further supports real-time updates on the client device 120, promptly delivering changes in the user's location and new data. The network infrastructure 160 employs encryption protocols, authentication mechanisms, and data integrity checks to protect data during transmission, ensuring user privacy and system integrity.

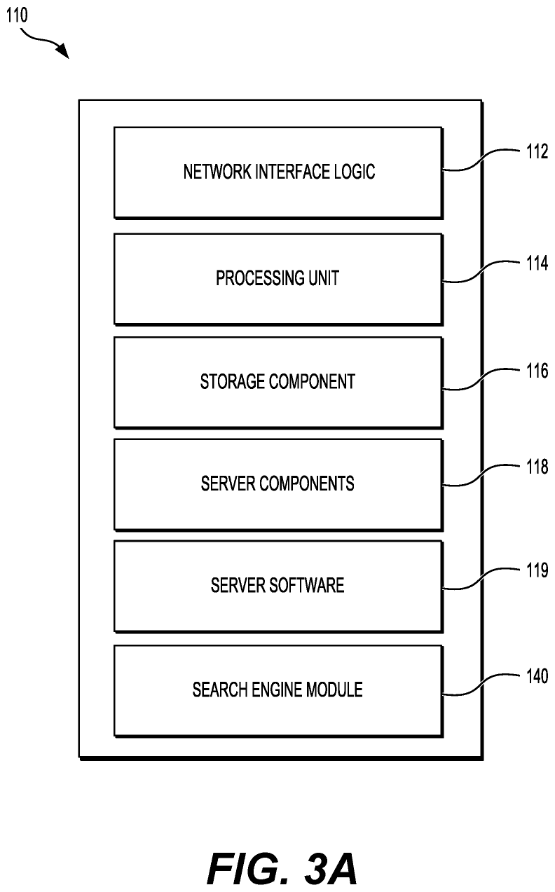

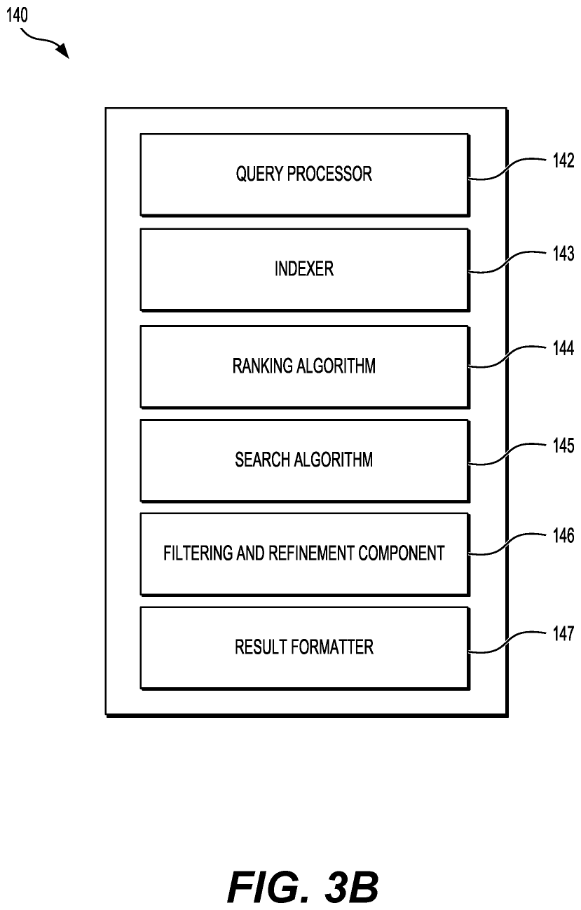

As previously indicated in connection with FIG. 1, the high-performance server 110 can manage and orchestrate various system operations. It serves as the central processing hub within the location-based system 100. The high-performance server 110 of the internet-based embodiment functions as the central processing unit (CPU) responsible for processing, storing, and retrieving banned work data. Referring now to FIG. 3A, the high-performance server 110 can include a network interface logic 112, processing unit 114, storage component 116, server components 118, and server software 119. It can involve constant and uninterrupted monitoring, maintenance, and optimization to ensure the continuous operation, reliability, and performance within the location-based system 100.

The network interface logic 112 of the high-performance server 110 facilitates internal communication among system components and external communication with the broader network environment. Its functionality adapts to the demands of these two communication types. The network interface logic 112 ensures seamless data and information exchange across the location-based system 100, including with external services, the database 130, and the client device 120. The external services can include any third-party services or systems that the location-based system 100 may communicate with or access for various functionalities. These include services related to mapping and geolocation data (e.g., GPS services), external databases or data sources, authentication and authorization services, and other services that the location-based system 100 can rely on to provide its features and functions. The network interface logic 112 facilitates communication over a wide range of network types, including the internet, cellular networks, Wi-Fi, Ethernet, fiber optics, satellite networks, and various wired or wireless networks. It establishes robust communication channels between the high-performance server 110 and the network infrastructure 160, optimizing the efficiency and reliability of data transmission within the broader network environment.

The processing unit 114 of the high-performance server 110 serves as the computational engine of the location-based system 100. Comprising dedicated hardware components, operating systems, and specialized software applications, it efficiently manages the computational demands for locating banned works in the location-based system 100. One function is data processing and the execution of search queries. Through seamless coordination with other system components and the utilization of geospatial coordinates, user-specific geolocation data, and other relevant data, it accurately identifies and retrieves information about banned works within the user's current location, chosen geographic area, or specified point of interest. The processing unit 114 effectively contributes to mapping banned work data in concert with the mapping module 150. It utilizes available geolocation data to precisely associate banned work data with their respective locations within the location-based system 100.

The storage component 116 serves as a general-purpose storage area for various data that support the overall functionality and performance of the location-based system 100. This could include system configuration data, such as configuration settings, system logs, and other system-related data for the high-performance server 110 to operate correctly; user data, such as information related to user accounts, preferences, and profiles for providing personalized services and adjusting or removing the default present radius within the location-based system 100; cache data, such as temporary data or cached content that can help improve the system's performance by reducing the need to fetch frequently accessed information from other sources; session data, such as information related to user sessions, login status, and session tokens to manage user interactions with the location-based system 100; system logs, such as logs of system activities, errors, and events for monitoring and troubleshooting purposes; and metadata about the banned works data stored in the database 130, which could include information such as timestamps, update history, or other relevant details. Data in the storage component 116 remains accessible even when the high-performance server 110 is not actively running or during system restarts, contributing significantly to the overall reliability and uninterrupted functionality of the location-based system 100. The storage component 116 can also interface with other system components to collectively support the operations of the location-based system 100.

The server components 118 encompass a range of functionalities designed to enhance the performance, security, reliability, and manageability of the high-performance server 110. The server components 118 can include security features, backup and recovery mechanisms, and tools for monitoring and managing the health and resources of the high-performance server 110. Security components form a robust defense against unauthorized access, potential breaches, and various security threats. The security components incorporate elements such as firewalls, intrusion detection systems, encryption mechanisms, and access control systems. Backup and recovery components can facilitate regular data backups and implement mechanisms to restore data in the event of system failures, disasters, or data corruption. This capability ensures data integrity and reduces the risk of data loss even in challenging scenarios. Additionally, monitoring and management tools can be used to track the performance, resource utilization, and overall system health of the high-performance server 110. Administrators can use the monitoring and management tools to closely monitor and manage the high-performance server 110, ensuring smooth operation of the system and identifying potential issues.

The server software 119, operating on the high-performance server 110 within the location-based system 100, serves as an intermediary between the client device 120 and system components, notably the database 130. Within the suite of server software 119, the database management system (DBMS) software can be seamlessly integrated. The DBMS software is responsible for efficiently managing and controlling the database 130, which stores information regarding banned works and other relevant information. It handles certain tasks encompassing data storage, retrieval, indexing, transaction management, concurrency control, and security. The high-performance server 110 can provide computational resources and infrastructure to support the efficient operation of the DBMS software and the overall management of the database 130. Additionally, administrators can employ performance monitoring tools and techniques leveraging the server software 119, including monitoring query execution times, database response times, and system resource usage, to gauge system performance, identify bottlenecks, and optimize resource utilization. The DBMS software can take on various forms. In some embodiments, it can be a Relational Database Management System (RDBMS), such as MySQL, Oracle, Microsoft SQL Server, or PostgreSQL, well-suited for structured data storage and retrieval. In other embodiments, the DBMS software can be a Geographic Information System (GIS) Database, designed for managing geospatial coordinates, a Document-Oriented Database Management System, fitting for flexible and semi-structured data, a Graph Database Management System, adept at handling interconnected data, or a NoSQL Database Management System, offering scalability for unstructured or semi-structured data. Standardized database connectivity protocols such as Open Database Connectivity (ODBC) or Java Database Connectivity (JDBC) can be utilized to establish seamless connections for various operations between system components within the location-based system 100, including the client device 120, search engine module 140, mapping module 150, and the DBMS software responsible for managing the database 130. The protocols facilitate effective communication between the system components and the DBMS software. Moreover, the DBMS software can provide Application Programming Interfaces (APIs) or Software Development Kits (SDKs), enabling system components to interact with the database 130 via programmed queries, data retrieval, updates, and resource management.

The network infrastructure 160 facilitates smooth data management in the high-performance server 110 by ensuring efficient data transfer, seamless communication, scalability, performance, and data security within the high-performance server 110. The network infrastructure 160 facilitates the seamless transfer of data between the high-performance server 110 and the system components of the location-based system 100. It ensures reliable and efficient data transmission over the network, promoting smooth communication and interaction among different system components. Moreover, the network infrastructure 160 establishes connections for the high-performance server 110 to interface with the database 130, streamlining the retrieval and storage of data. The network infrastructure 160 ensures that data requests can be processed quickly and that the high-performance server 110 can access the information from the database 130 without delays or interruptions. The network infrastructure 160 supports the scalability and performance of the high-performance server 110 and provides network resources and bandwidth to handle increased data traffic, user requests, and concurrent connections. It enables the high-performance server 110 to adeptly manage data operations, sustain responsiveness, and deliver peak performance even during periods of high usage. The network infrastructure 160 incorporates security measures to protect data during transmission and maintains secure communication between the high-performance server 110 and the system components. This is achieved by implementing encryption, authentication, and other security protocols to safeguard sensitive information and preserve data integrity.

As previously indicated in connection with FIG. 1, the search engine module 140 can optimize performance, scalability, and user experience. It can be configured in two main ways. In some embodiments, the search engine module 140 is hosted within the high-performance server 110. This configuration ensures efficient and seamless communication between system components. In this configuration, the search engine module 140 leverages the substantial processing power and resources of the high-performance server 110 to process search requests and generate highly accurate search results based on predetermined search criteria and search queries. In other embodiments, the search engine module 140 can be implemented as a standalone component. In this configuration, the search engine module 140 communicates with the high-performance server 110 and other system components over the network infrastructure 160.

Referring now to FIG. 3B, the search engine module 140 may include several components to streamline search operations and ensure accurate search results. It can include a query processor 142, indexer 143, ranking algorithm 144, search algorithm 145, filtering and refinement component 146, and result formatter 147 that work together to streamline the processing of search requests and ensure search results are accurate, targeted and adequately formatted for presentation to the user. The search engine module 140 may include additional components or logic to handle network connectivity, communication protocols, and data transfer over the internet.

The location-based system 100 provides a user-friendly interface that allows users to interact with the search engine module 140 and can be tailored to accommodate different user preferences, including a web-based interface optimized for desktop or mobile browsers and a mobile-friendly interface optimized for touch interactions and smaller screens. The query processor 142 can employ a combination of techniques, including parsing, Natural Language Processing (NLP), keyword analysis, contextual understanding, and potentially machine learning, to decipher the user's search intent. It aims to extract the meaning behind the search query to provide relevant and accurate search results. The indexer 143 creates and maintains a well-structured index of data stored in the database 130 and can facilitate rapid and efficient search and retrieval processes. The ranking algorithm 144 can determine the display order of the search results based on various factors, such as machine learning techniques and artificial intelligence for improving performance and adapting to changing user behaviors and preferences, to ensure search results align with user preferences. The search algorithm 145 can execute actual search operations within the database 130 based on predetermined search criteria and search queries, employing advanced techniques, such as filtering and relevance scoring, to identify matching records. The filtering and refinement component 146 applies additional filters and fine-tunes search results to produce more refined search outcomes. This further defines the search results based on specific filters, such as radius distance (e.g., 1 mile, 5 miles, 10 miles) for further narrowing or expanding the boundary within which the location-based system 100 will search for banned works, thematic elements (e.g., LGBTQIA+, abortion, discrimination, racism, mental illness, politics, poverty, religion, teenage pregnancy), genre/categories (e.g., young adult, adult, picture book, chapter book, fiction, non-fiction, science fiction, mystery), or other attributes (e.g., publication date, language, format, edition). Within the location-based system 100, terms exhibit versatility. They can function as search queries, initiating a comprehensive search across a given topic. In other aspects, these terms can adapt into filter categories, allowing users to pinpoint a search by focusing on distinct aspects of interest or boundaries. The location-based system 100 imposes no constraints on whether a term should be designated as a search query or filter category. The result formatter 147 can present the generated search results to a user by structuring the information, highlighting details, and displaying the results in a user-friendly and visually appealing manner.

As will be appreciated, the search engine module 140 seamlessly integrates with user-specified geolocation data obtained automatically from a client device 120 or employs geocoding to convert user-provided location-based information into geospatial coordinates. It leverages real-time GPS and geospatial coordinates to facilitate a broad spectrum of location-based searches. The search engine module 140 can process search criteria and queries to deliver relevant search results tailored to the user's physical location, geographical area of interest, or point of interest. The search engine module 140 sends requests to external data providers or geocoding services, such as Google Maps Geocoding API and Bing Maps Location API, that maintain comprehensive databases of geographic locations and their coordinates. The external services match the search requests with precise coordinates and return the coordinates to the search engine module 140 for seamless integration. The search engine module 140 performs search operations within the database 130 that stores information about banned works, comprehensive information, location data, and other relevant attributes. It utilizes the search algorithm 145 and other logic to generate location-specific and targeted search results based on the search criteria and queries and the data available in the database 130.

In various embodiments, the location-based system 100 enhances its capacity to handle increased user activity and data loads by distributing the search engine module 140 across multiple servers or nodes. Load balancing algorithms are employed to distribute incoming search requests among these servers or nodes, taking into account their processing capabilities and current workloads. This distributed architecture ensures efficient operation for each server or node, preventing overload and maintaining responsive search performance, especially during peak usage. As users engage with the location-based system 100, the workload is efficiently distributed across these nodes, thereby averting performance bottlenecks and accommodating a growing user base and expanding data repositories. Moreover, the distributed search engine module 140 incorporates a real-time data synchronization mechanism to uphold the integrity and accuracy of search results. This mechanism enables seamless updates and data changes, ensuring that the search results remain current and aligned with recent data. Users can confidently rely on the location-based system 100 to deliver precise and up-to-date search outcomes. Furthermore, the distributed search engine module 140 features fault tolerance and redundancy mechanisms to address server or node failures. These mechanisms automatically reroute search requests to operational nodes using routing algorithms that determine the appropriate destination for each request, thus reducing service interruptions. Additionally, redundant data storage across multiple nodes mitigates the risk of data loss and reinforces system resilience. The distributed nature of the search engine module 140 optimizes data retrieval and processing efficiency, as it allows for parallel data retrieval and processing operations across nodes. Consequently, latency and response times are reduced, ensuring rapid delivery of search results, even when dealing with extensive datasets.

The network infrastructure 160 contributes to the efficient functioning of the search engine module 140 within the high-performance server 110. The network infrastructure 160 enables connectivity, data retrieval, data processing, distributed computing, and real-time updates while ensuring secure and reliable communication. The network infrastructure 160 provides connectivity between the search engine module 140 and other components of the location-based system 100, including the database 130, to access and retrieve data. Additionally, the network infrastructure 160 facilitates communication between the search engine module 140 and external data providers or APIs to fetch data, such as geospatial coordinates, relevant to the search criteria. The network infrastructure 160 ensures that the search engine module 140 can establish connections with the external sources and retrieve the relevant information and data for processing and analysis. Further, the network infrastructure 160 supports communication and data exchange among distributed components and facilitates efficient data distribution, parallel processing, and coordination among distributed nodes of the search engine module 140.

The architecture of the mobile application-based system differs from the internet-based system. In an alternative embodiment, instead of a high-performance server 110, the location-based system 100 leverages the capabilities of the mobile application 12 to handle data processing, storage, and communication with external services or databases 130 in a mobile application-based system. The mobile application 12 seamlessly integrates with external services through a dedicated network communication logic, allowing real-time access to location-based information. When users engage with the mobile application 12, the network communication logic assembles user requests and constructs structured queries. These queries are then transmitted to external services, including mapping and geolocation APIs via the internet. Once responses are received, the mobile application 12 employs data processing techniques to extract details, including location coordinates and comprehensive information about the banned works. This processed data is presented through a user-friendly interface, which may include interactive maps or comprehensive banned work information. The search engine module 140 can support offline capabilities to ensure uninterrupted functionality, enabling local data storage and processing on the user device 120B for user searches when an internet connection is unavailable.

The network infrastructure 160 facilitates communication between the mobile application 12 and external entities over secure channels. The mobile application 12, serving as the client, directly communicates over the network infrastructure 160, serving as the intermediary, to effectively communicate with external servers or cloud-based resources to obtain information about the banned works, geolocation data, and geographic details. The mobile application 12 utilizes network protocols, sends requests in a format suitable for network transmission, and awaits information about the banned works and their associated locations.

As previously indicated in connection with FIG. 1, the database 130 serves as a foundational component within the location-based system 100 in the storage, organization, and security of diverse data. It functions as a repository for storing comprehensive information about banned works, such as titles, descriptions, creator biographies, additional creator works, recommended works, publication dates, reasons or grounds for bans, relevant historical and cultural context, authoritative legal and administrative decisions, and other relevant information. Additionally, the database 130 maintains nearby locations where banned works are available, such as library inventory and venue specifics. This extensive dataset is systematically organized for efficient data retrieval and management. As will be appreciated, a capability of the database 130 is its integration with geolocation technology. The database 130 manages and retrieves location-related data, including geospatial coordinates of geographical areas of interest or points of interest. In addition, the location-based system 100 can query the database 130 to find banned works with geospatial coordinates falling within a defined radius from the user's location, geographical areas of interest, or points of interest. It can be used in conjunction with geolocation data to deliver tailored search results based on the client device 120 and the user's current location.

The database 130 can be public, private, or a combination of both, and be one or more databases or a plurality of interconnected databases that comprehensively and systematically catalog banned works from various sources. Each database 130 can contain different types of information and contribute to the overall functionality of the location-based system 100. The database 130 can be configured for periodic updates to ensure data integrity and reliability, such that outdated or lifted bans are removed from, and new data is added to, the database 130, ensuring the catalog of banned works remains up to date. Moreover, the database 130 can be designed to scale efficiently as the usage of the location-based system 100 grows. It can be implemented as a distributed, highly scalable, and fault-tolerant NoSQL database system, such as Apache Cassandra or Apache Hbase, capable of handling vast amounts of data.

In some embodiments, the location-based system 100 can integrate with existing public and private databases. The integration with existing public and private databases depends on various factors, including the compatibility of data structures, database technologies, security considerations, and the availability of appropriate APIs or interfaces for data access, aligned with the system's requirements. Integration efforts may involve developing custom connectors, adapters, or middleware to facilitate communication and data exchange between the location-based system 100 and existing databases. If the existing databases already contain the required components of the database 130 and are compatible with the location-based system 100, they can be integrated without significant modifications. However, if the existing databases do not have all the required components, some modifications or additions may be necessary to ensure seamless integration with the location-based system 100. This can involve mapping the data from the existing databases to fit the structure and format expected by the location-based system 100. Data transformation and migration processes may be required to align the existing database schema. The location-based system 100 can utilize existing databases by establishing secure connections and appropriate database connectivity protocols, such as ODBC or JDBC, to interact with the data, thereby implementing authentication and authorization mechanisms to access the required data. The location-based system 100 can send queries to retrieve relevant information from the existing databases, perform updates, and synchronize data as needed. The location-based system 100 can utilize the existing databases' resources, data, and functionality without duplicating or migrating all the data into its database. In other embodiments, the location-based system 100 can access, query, and extract information from existing databases as needed, without directly integrating them or physically merging the data. Connections to the existing databases can be established using appropriate database connectivity protocols or utilizing specific APIs provided by the existing databases. The location-based system 100 can then send queries to retrieve relevant data from the databases, process it, and incorporate it into its operations or processes. Utilizing the data from existing databases without full integration allows the location-based system 100 to benefit from the available information without requiring extensive data migration or duplication. Real-time or on-demand access to the data in the existing databases will ensure the location-based system 100 can access up-to-date information. When incorporating data from existing databases, the location-based system 100 could take measures to address compatibility, security, and performance factors. This includes managing data access rights, maintaining data consistency, and addressing potential performance limitations that could arise during external database queries. Any updates or changes to the existing databases may include corresponding adjustments in the location-based system 100 to accommodate the modified data structure or content. Utilizing data from existing databases in the location-based system 100 can provide access to a broader range of information and enhance the system's functionality without complete database integration.

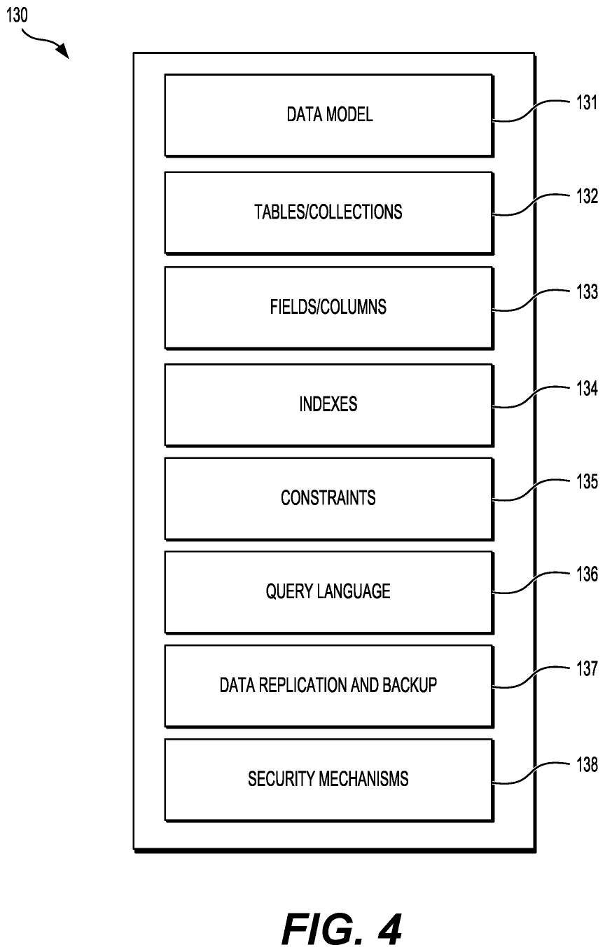

FIG. 4 depicts a database system suitable for use in an example embodiment of the location-based system 100. The choice of a database and its specific configuration is contingent upon the requirements and architectural considerations of the system, with the primary goal being the efficient management, security, and reliability of data. In some embodiments, the database 130 can comprise components having structural and functional elements. It can include a data model 131, tables/collections 132, fields/columns 133, indexes 134, constraints 135, query language 136, data replication and backup 137, and security mechanisms 138. The components of the database 130 work together to organize, store, retrieve, and secure the data within the location-based system 100. The data is structured, accessible, and protected, including storing and managing banned works information.

The data model 131 of the database 130 defines the structure and organization of the data stored in the database 130. The data model 131, such as relational databases, document-oriented databases, and graph databases, can determine how the data is represented, related, and accessed within the location-based system 100. The data model 131 can include entities, such as users, banned works, locations, and other relevant entities. The relationships between the entities are defined in the data model 131. In a relational database, data is organized into tables; in a document-oriented database, data is stored in collections; and in a graph database, data is organized or stored using a graph model including nodes and edges where the data is represented as a collection of interconnected nodes and relationships between them. The tables/collections 132 in the database 130 can correspond to the different types of data entities within the location-based system 100, such as a “Users” table or collection to store user information and a “BannedWorks” table or collection to store information about banned works. Fields/columns 133 represent the individual data elements within a table or collection. Each field stores a specific type of data, such as usernames, banned work titles, geolocation coordinates, or timestamps. The fields/columns 133 within the tables/collections 132 of the database 130 can correspond to the attributes or properties of the respective entities within the location-based system 100. Indexes 134 are data structures that improve the efficiency of data retrieval operations. The indexes 134 can provide a quick lookup mechanism based on specific attributes or fields/columns 133. The indexes 134 can speed up searches for banned works based on attributes such as title, location, or user. The database 130 can quickly and efficiently locate relevant banned works data when executing search queries by creating indexes 134 on the fields/columns 133. Constraints 135 ensure the integrity and consistency of the data stored in the database 130 and can define rules and conditions to which the data adheres, such as ensuring distinct user IDs, enforcing referential integrity between tables/collections 132, or setting constraints 135 on the allowed values for fields/columns 133. The database 130 can provide a query language 136, such as Structured Query Language (SQL) for relational databases and MongoDB Query Language for document-oriented databases, that enables users to interact with the data stored in the database 130. The query language 136 enables users to retrieve, manipulate, and analyze the data using specific syntax and commands. It enables the location-based system 100 to perform operations, including retrieving banned works based on predetermined search criteria and search queries, filtering results, and aggregating data. The database 130 can implement mechanisms for data replication and backup 137 to ensure data availability and reliability. The data replication functionality can involve creating copies of the database 130 across multiple servers to provide redundancy and improve fault tolerance. The backup functionality can enable regular snapshots or copies of the database 130 to be created for recovery in case of data loss or system failures. The data replication and backup functionalities ensure that the location-based system 100 and banned works data are resilient and can be restored in the event of any issues. The database 130 can incorporate the security mechanisms 138, such as user authentication, role-based access control, encryption of sensitive data, and auditing mechanisms for tracking data access and changes, to protect the stored data from unauthorized access, modification, or disclosure. The security mechanisms 138 ensure that the location-based system 100 and banned works data are securely stored and accessed only by authorized users.

The network infrastructure 160 enables seamless access to the database 130 for efficient data retrieval and storage operations in the location-based system 100. The network infrastructure 160 ensures that the system components of the location-based system 100, such as the high-performance server 110, client device 120, search engine module 140, mapping module 150, and other relevant components, can establish connections with the database 130. This connectivity ensures the system components communicate and interact with the database 130, exchanging data and performing operations. Further, the network infrastructure 160 facilitates data retrieval from the database 130 to the necessary system components. When a component sends a data retrieval request, the network infrastructure 160 ensures that the request is transmitted to the database 130, and the retrieved data is efficiently transmitted back to the requesting component. The network infrastructure 160 also enables the storage of data in the database 130 by providing the necessary communication channels between the components and the database 130. When a component may need to store data, it sends it through the network infrastructure 160 to the database 130, ensuring proper storage. The network infrastructure 160 also ensures secure and reliable communication between the components and database 130. It may employ encryption protocols and the security mechanisms 138 to protect the data during transmission, preventing unauthorized access, tampering, or interception of sensitive information. In some embodiments, the network infrastructure 160 supports efficient data management by enabling the components to perform operations, such as data updates, inserts, and deletions in the database 130. It ensures that the components can send commands or requests to the database 130 and receive the appropriate responses, facilitating smooth data management processes.

As previously indicated in connection with FIG. 1, the mapping module 150 primarily focuses on data mapping, distance calculations, and spatial inquiries. Specifically, it associates the information regarding banned works, sourced from the database 130, with many data points based on geospatial coordinates for the location-based search criteria or user-specific geolocation data for the automatic geolocation search criteria. This involves matching the particulars of banned works, including details such as library inventory and availability, with precise geospatial coordinates. The mapping module 150 enables the location-based system 100 to furnish users with contextually pertinent data concerning the accessibility and physical placement of banned works. The functionality of the mapping module 150 enables users to not only visualize the geographical dispersion of the banned works but also to identify nearby venues or locations where the banned works are accessible. As such, the location-based system 100 enables users to make informed decisions based on their specific geolocation or proximity preferences in relation to their current physical locations, geographical areas of interest, or points of interest.

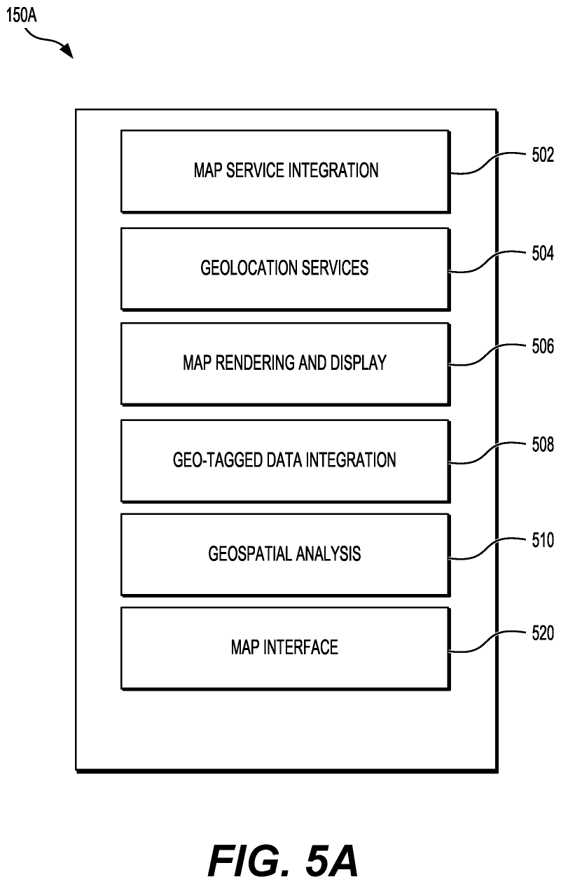

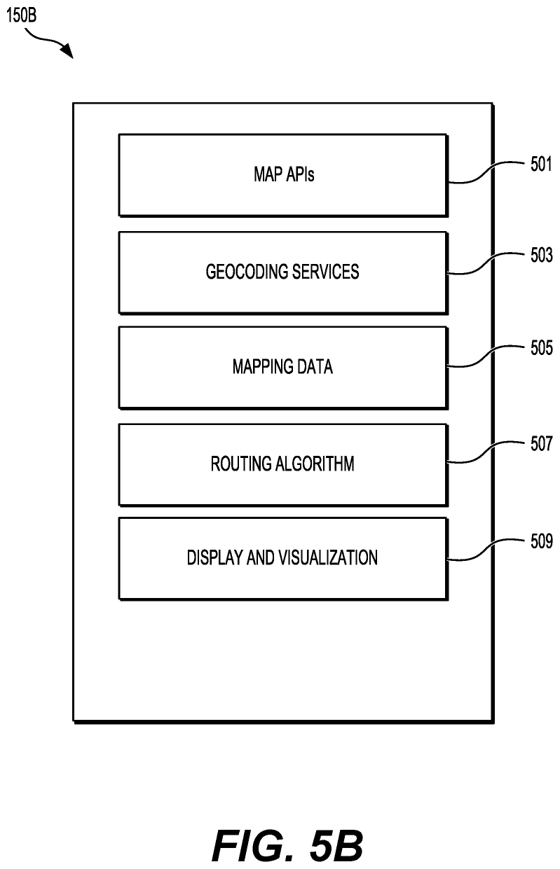

FIG. 5A illustrates the mapping module 150A of the location-based system 100 according to an example embodiment. Referring to FIG. 5A, the mapping module 150A can include a map service integration 502, geolocation services 504, map rendering and display 506, geo-tagged data integration 508, geospatial analysis 510, and an interactive map interface 520. The map service integration 502 can integrate with third-party map service providers, such as Google Maps or OpenStreetMap, to access map data, functionalities, and services via APIs. Banned work data can be incorporated into the map data, enabling the mapping module 150A to display the presence or locations of banned works on an interactive map interface 520. The interactive map interface 520 can facilitate the accurate representation and visualization of data, enabling users to view and interact with the location-based information by utilizing mapping technologies and algorithms. It can be embedded within a webpage or a dedicated section of the website. Geolocation services 504 determine the geographic location of the user, client device 120, or Internet Protocol (IP) address, enabling the mapping module 150A to provide location-based services and relevant mapping information. The mapping module 150A can utilize geolocation services 504 to provide location-specific and targeted information about banned works. The map rendering and display 506 enables users to interact with the interactive map interface 520, such as exploring different locations and accessing map-related features. The mapping module 150A can visually represent banned work locations, boundaries, or areas of restricted access on the interactive map interface 520, enabling users to access and locate banned works in a user's geographical context. The geo-tagged data integration 508 can integrate with external data sources or databases containing geographically tagged information, such as geographical areas of interest, points of interest, user-generated content, or location-specific data. The mapping module 150A can incorporate the geo-tagged data related to banned works, enabling users to search, query, or visualize the locations of the works, on the interactive map interface 520. It can also employ geospatial analysis 510 to analyze and process data related to banned works. The mapping module 150A incorporates geospatial algorithms and functionalities to enable users to perform spatial queries, proximity searches, and other spatial operations on the map data.

FIG. 5B illustrates the mapping module 150B of the location-based system 100 according to another example embodiment. Referring to FIG. 5B, the mapping module 150B can include map APIs 501, geocoding services 503, mapping data 505, routing algorithm 507, and display and visualization 509. The map APIs 501 can be software interfaces provided by mapping service providers, such as Google Maps API or Mapbox API, that enable the mobile application 12 to interact with the mapping services and access map data, including geographic features. The mapping module 150B can utilize the APIs to overlay or associate banned work data with specific locations on the mobile application interface, enabling users of the mobile application 12 to visually identify banned works in a user's geographical context. The mapping module 150B can use geocoding services 503 to translate location-based inputs, including geographical areas of interest and points of interest, related to banned works into specific coordinates, enabling the identification and mapping of banned work locations accurately. It can leverage comprehensive mapping data 505, including geographic features, roads, and landmarks, to provide accurate and up-to-date maps on a dedicated screen or view within the mobile application 12. The mapping module 150B can employ routing algorithms 507 to determine the best routes and directions between different locations. The display and visualization 509 functionality can display markers, icons, or other visual representations to indicate the presence or proximity of banned works by incorporating banned work data into the mapping data 505. Users can zoom in and out, pan across the map, and interact with the displayed elements using touch gestures and controls.

Depending on the architectural and design choices within the location-based system 100, the placement or location of the mapping module 150 can exhibit variability. In some embodiments, the mapping module 150 can be logically integrated and tightly coupled with software or hardware architecture of the high-performance server 110, and seamlessly incorporated and interconnected with other system components of the location-based system 100. In other embodiments, the mapping module 150 can be housed within the high-performance server 110 by locating the mapping module hardware or software within the server enclosure. In other embodiments, the mapping module 150 can be housed in a separate server, or a cluster of servers dedicated to handling mapping-related tasks, creating a distinct server or server infrastructure designated explicitly for the mapping operations of the mapping module 150. In other embodiments, the mapping module 150 can be distributed across multiple servers or nodes within the network infrastructure 160. Each server or node can handle specific mapping functionalities, allowing for scalability and fault tolerance. In other embodiments, the mapping module 150 can be hosted in a cloud computing environment, such as a virtual server or a containerized service, allowing flexibility, scalability, and ease of deployment.

The network infrastructure 160 facilitates the efficient operation of the location-based system 100, particularly in supporting the mapping module 150. It enables the integration of the mapping module 150 with location-based services, such as geolocation, geocoding, routing, and venue lookup. Furthermore, the network infrastructure 160 facilitates seamless communication between the mapping module 150 and the mobile application interface of the mobile application 12, ensuring the smooth exchange of data and instructions. This capability extends to scenarios where the mapping module 150 is distributed across multiple servers or nodes, enabling robust communication and data exchange among these components. Additionally, the network infrastructure 160 supports distributed computing, including data partitioning and parallel processing, for the secure and efficient operation of the mapping module 150, especially when handling substantial mapping tasks. The network infrastructure 160 also employs encryption protocols, authentication mechanisms, and data integrity checks for data transmitted between the mapping module 150 and other system components to maintain data integrity and protect sensitive information.

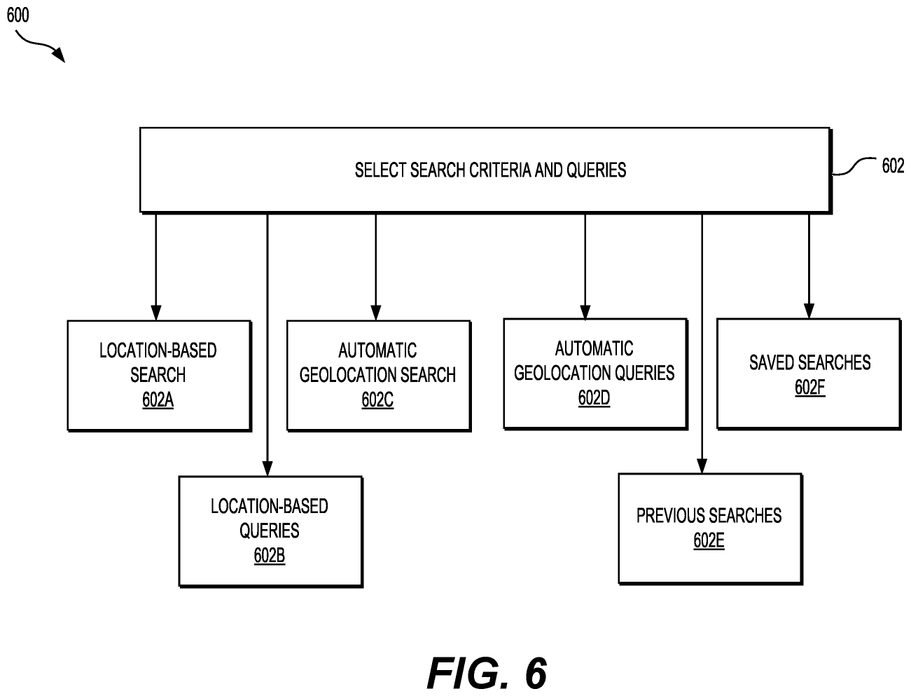

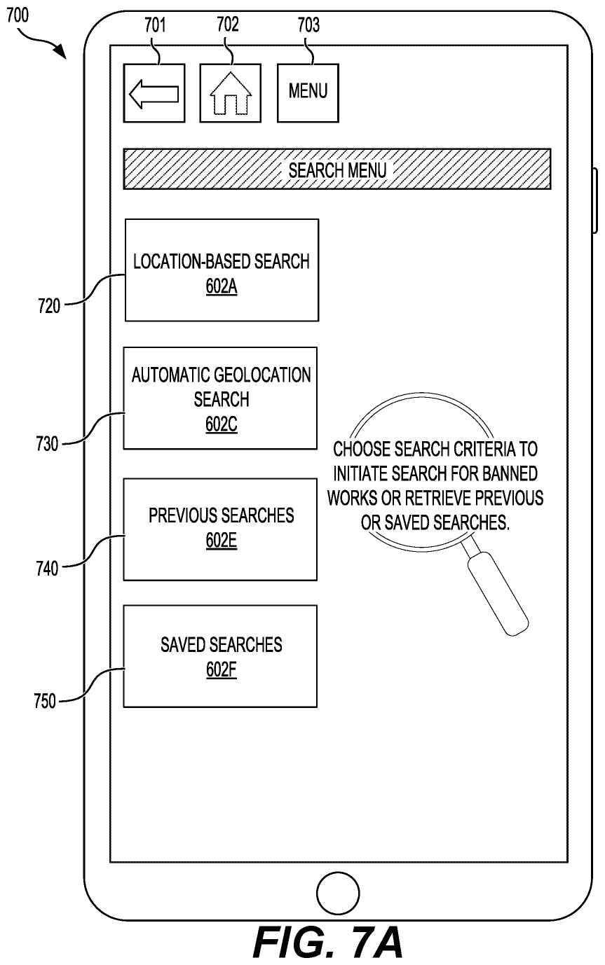

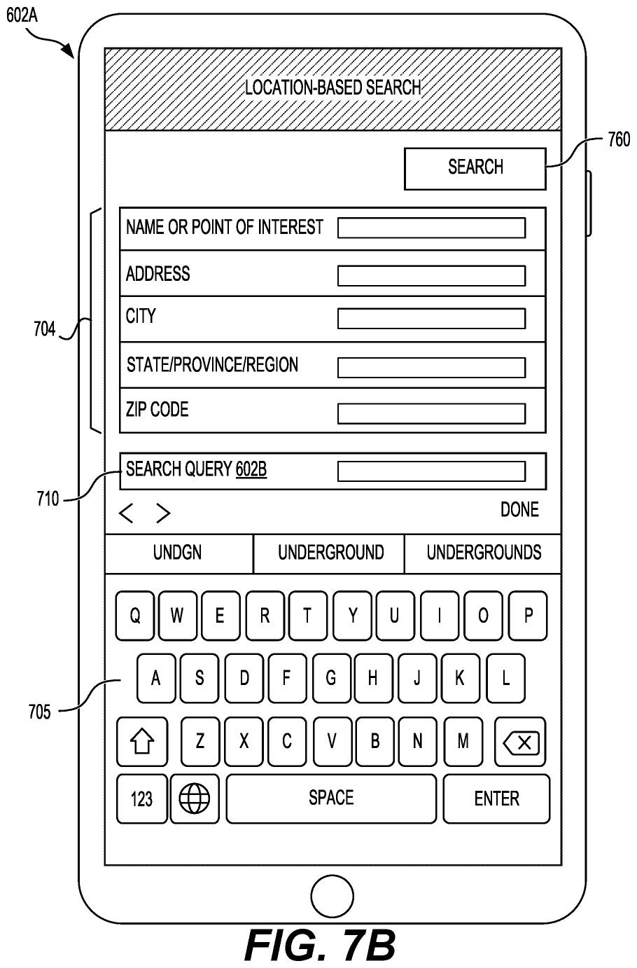

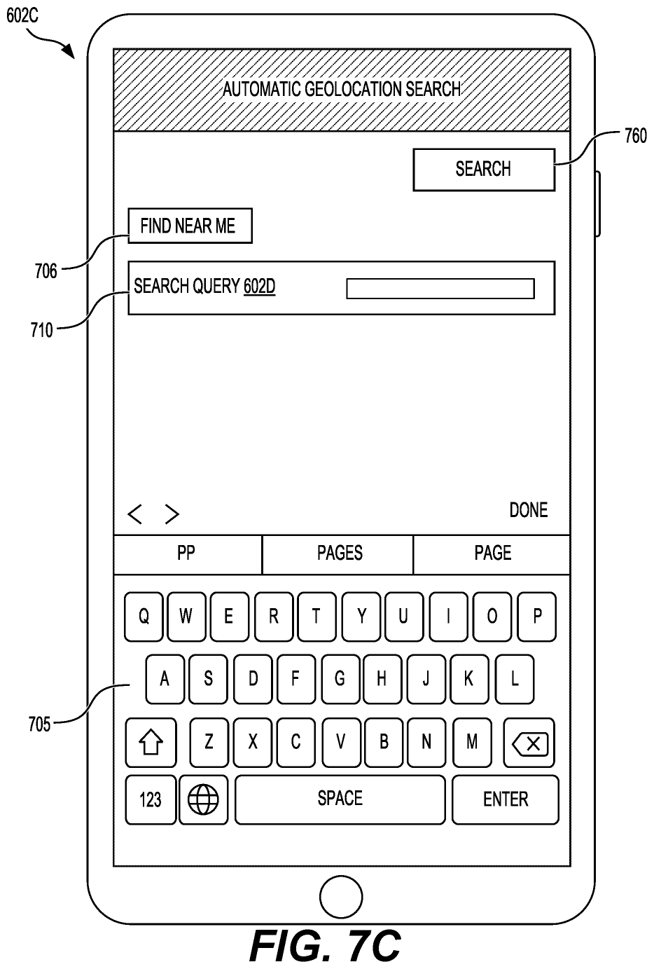

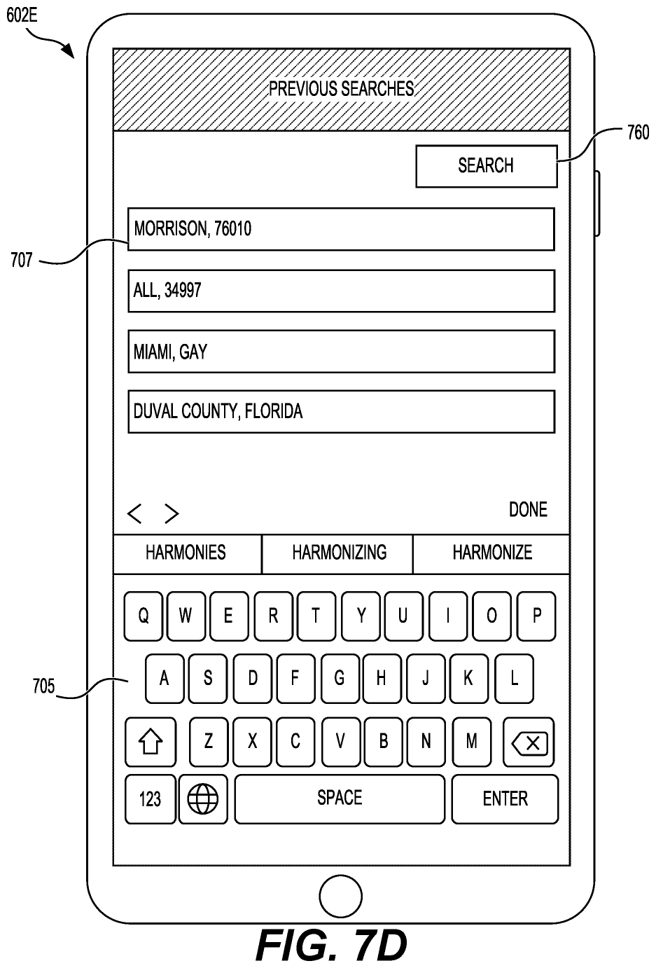

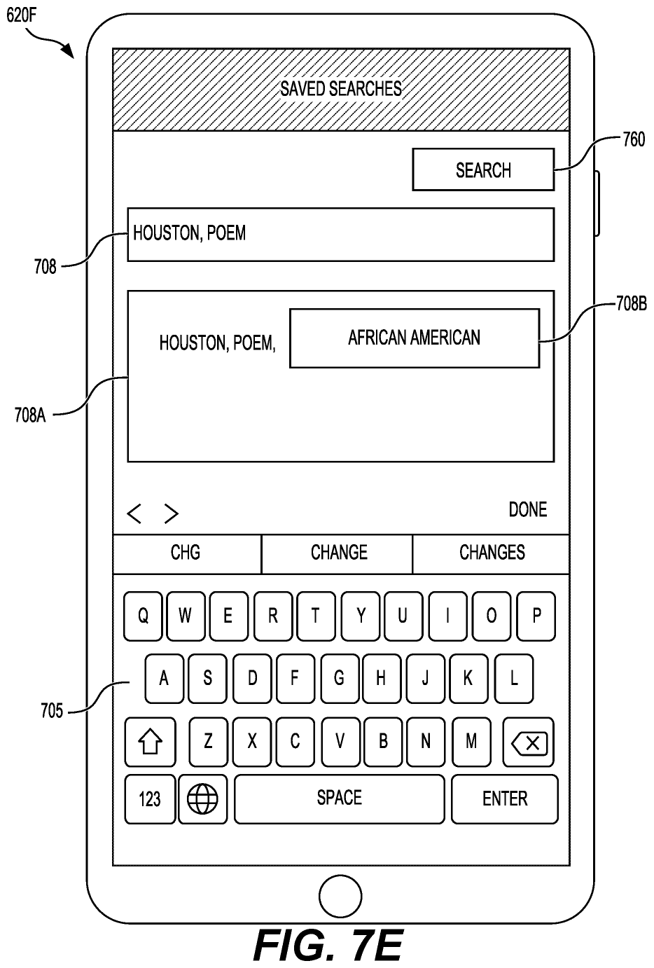

FIG. 6 depicts the process of searching for banned works 600 that may be implemented by the system in FIG. 1. In an example embodiment, users can access the location-based system 100 through a web-based interface using a web browser or other suitable client software on their computer. At step 602, the user selects search criteria from a search menu 700 (FIG. 7A). If the user selects the location-based search (step 602A), geographic areas of interest, such as an address, city, state, tribal, and territorial regions, and location-related description, or points of interest, such as education institutions and public transportation, can be entered using the user interface 120A or internet-connected device. The user's location input is sent to external geolocation services or APIs. These services are responsible for converting the location input into geospatial coordinates, specifically latitude and longitude coordinates, which precisely identify the specified boundaries, geographic area of interest, or point of interest. Once the geospatial coordinates are obtained, the search engine module 140 of the high-performance server 110 sends a search request incorporating the geospatial coordinates to the database module. The database module then accesses one or more databases 130 containing comprehensive information about the banned works and their associated locations. The database module retrieves data related to banned works that match the search request. After obtaining the data from the database module, the mapping module 150 enables precise mapping of the banned work data to specific geographic points based on the data from the databases 130. The mapping module 150 then generates search results tailored to the user's defined geographic area of interest or at a specific point of interest. Users can interact with the search results through the user interface of the client device 120 (e.g., web browser) and view comprehensive information about the banned works. The user can further apply filters to narrow the search results.

If the user selects the automatic geolocation search (step 602C) using an option such as “Find Near Me”, a web browser detects the geolocation request and presents a prompt to the user asking permission to access their location. The request can be a prompt, such as “Allow website to access your location? Allow or Deny.” The user can decide whether to allow or deny the request for access to their geolocation data based on privacy or necessity considerations. If the user allows the request, the browser gathers the geolocation data using the device's GPS, Wi-Fi, or other available location-detection hardware, retrieving precise latitude and longitude coordinates. Many modern web browsers come equipped with built-in geolocation capabilities. Users also retain the option to modify location permissions for the website at any time by adjusting site settings to suit their preferences. Once the geolocation data is obtained, the search engine module 140 of the high-performance server 110 sends a search request incorporating the user's geolocation data to the database module. The database module then accesses one or more databases 130 containing comprehensive information about the banned works and their associated locations. The database module retrieves data related to banned works that match the search request. After obtaining the data from the database module, the mapping module 150 enables precise mapping of the banned work data to specific geographic points based on the data from the databases 130. Next, the mapping module 150 generates search results tailored to the user's real-time geographical context. Users can interact with the search results and view comprehensive information about the banned works. The user can further apply filters to narrow the search results.

Users can enter search queries (steps 602B, 602D), which can include keywords, such as creators (e.g., authors, musicians, poets, artists, choreographers, playwrights, designers, video game developers, publishers, producers, photographers), and radius distance (e.g., 1 mile, 5 miles, 10 miles) for further narrowing or expanding the boundary within which the location-based system 100 will search for banned works, along with the selection of either the location-based search 602A or automatic geolocation search 602C criteria to identify banned works near their geographical position, within a defined geographic area of interest, or at a specific point of interest. The search engine module 140 of the high-performance server 110 can parse and identify individual words, numbers, or phrases within the search query. Each word or phrase can be tokenized into smaller units for easier processing. In various embodiments, spaces or commas are used as token separators. The search engine module 140 searches for records in the database 130 that match the individual tokens or keywords, including partial matches, synonyms, or variations of the keywords, ranked by relevance, in conjunction with the user-specific geolocation data or geospatial coordinates. The database module accesses one or more databases 130 containing the comprehensive information about the banned works and their associated locations. The mapping module 150 maps the banned work data to specific geographic points based on the search query, geographical context, and information from the databases 130. Next, the mapping module 150 generates search results tailored to the user's geographical context. Users can interact with the search results and view comprehensive information about the banned works. The user can further apply filters to narrow the search results.

In an alternative embodiment, users can access the location-based system 100 through a dedicated mobile application 12 on a user device 120B. The mobile application-based system functions in a manner closely resembling the internet-based system, with minor distinctions as detailed. If the user selects the location-based search 602A, the user's location input is converted into geospatial coordinates within the mobile application 12. The search engine module 140, integrated within the mobile application 12, processes the search request, and the mobile application 12 communicates with a database module that accesses one or more databases 130 containing comprehensive information about banned works and their associated locations. The mapping module 150, integrated within the mobile application 12, maps banned work data to specific geographic points based on the user's specified geographic area and the information from the databases 130. The user receives search results specifically tailored to their specified geographic context on their user device 120B.

If the user selects the automatic geolocation search 602C, by selecting ‘Find Near Me’, using the mobile application 12 on a user device 120B, the user could receive a prompt requesting permission for the mobile application 12 to access the geolocation data stored on the user device 120B. The request can be a prompt, such as “Allow Underground Pages App to access your device's location? Allow or Deny.” If the user allows the request, the mobile application 12 utilizes the geolocation services of the user device 120B, which can include GPS, Wi-Fi positioning, cellular tower triangulation, or other location detection methods. The geolocation services of the user device 120B automatically acquire the user-specific geolocation data and transmit it to the mobile application 12. The mobile application 12 utilizes the geolocation data to provide tailored search results to the user. The user can later change location permissions in the user profiles and settings of the mobile application 12.

Users can enter search queries (602B, 602D) along with the selection of either the location-based search 602A or automatic geolocation search 602C criteria to identify banned works near their geographical position, within a defined geographic area of interest, or at a specific point of interest. The integrated search engine module 140 processes the search query in conjunction with the geospatial coordinates and user-specific geolocation data, and the mobile application 12 communicates with a database module that accesses one or more databases 130 containing comprehensive information about banned works and their associated locations. The integrated database module accesses one or more databases 130 containing comprehensive information about the banned works and their associated locations. The integrated mapping module 150 within the mobile application 12 maps the banned work data to specific geographic points based on the user's specified geographic location, within a defined geographic area of interest, or at a specific point of interest and the information from the databases 130. The user receives search results specifically tailored to their real-time geographical context.

In other embodiments, the user can initiate a search using previous searches (step 602E) or access saved searches (step 602F) for repeating a similar search in the same or a different location, comparing search results from different locations or different points in time, tracking banned works in various locations over time, referring back to searches for research or other purposes, applying different combinations of filters (e.g., different keywords, date ranges, locations), exploring different areas or aspects of banned works systematically, and returning quickly to prior searches. When users conduct a search and wish to save it for future reference, they can do so within the web-based application or mobile application. In subsequent interactions with the location-based system 100, the user can access saved searches using the saved searches 602F option. When the user selects one of their saved searches, the location-based system 100 (server-side logic of the high-performance server 110 or mobile application backend of the mobile application 12) retrieves the saved parameters and executes the search. The search results are then displayed to the user on the client device 120. Users can also modify or refine their saved searches before executing them again. The previous searches 602E option enables users to efficiently access and re-run searches they find useful or frequently use without manually inputting search criteria or search queries. The saved and previous search items can include geospatial coordinates, user-specific geolocation data, or user preferences obtained from search queries, enabling users to quickly find or refine the search results.

FIGS. 7A through 7E depict various display screens that users may encounter when searching for banned works according to an example embodiment. While the examples depict mobile application-based interfaces, the location-based system 100 can alternatively manifest as a web-based system accessible via URLs or other variations. Referring to FIG. 7A, a search menu 700 can include interactive elements, namely action buttons, such as back 701, home 702, and menu 703, and search criteria buttons, such as location-based search 720, automatic geolocation search 730, previous search 740, and saved search 750. The back button 701 can be used to navigate to the previous screen or step in the user interface. It is advantageous when users want to return to a previous search result, page, or screen within the web-based interface or user interface of the mobile application (e.g., search application). The home button 702 can take the user back to the main or home screen of the search application. It provides a quick way to get to the starting point of the search application. The menu button 703 can be used to access additional options or features of the search application. When selected, it can open a drop-down menu or slide-out panel that provides access to settings, filters, advanced search options, and other functionalities. Throughout the user interface, additional elements such as icons, placeholders, or tooltips may provide users with helpful hints or instructions.

As previously indicated in connection with FIG. 7A, selecting the location-based search button 720 from the search menu 700 can initiate the screen for the location-based search criteria 602A, as depicted in FIG. 7B. In this example embodiment, the screen can include interactive fields designed to accept text input, such as form fields 704 and input field 710. Users can tap on them to activate a keyboard 705 for entering search inputs, such as geographical areas of interest (e.g., address, city, state, zip code, tribal, territorial regions) or points of interest (e.g., map-based features) in the form fields 704 and search queries (constituting location-based queries 602B), such as keywords and/or radius distances for further narrowing or expanding the boundary within which the location-based system 100 will search for banned works, in the input field 710. In some embodiments, an autocomplete functionality can provide suggestions as the user types for faster input and accurate searching. A search button 760 can initiate the search process based on the input in the form fields 704 as well as the search query in the input field 710. The “Enter” button on the keyboard 705 can also initiate the search process. Either button (760, “Enter”) can trigger the location-based system 100 to process the inputs and retrieve relevant information from the database 130.

As previously indicated in connection with FIG. 7A, selecting the automatic geolocation search button 730 from the search menu 700 can initiate the screen for the automatic geolocation search criteria 602C, as depicted in FIG. 7C. In this example embodiment, the screen includes a prominent feature in the form of a “Find Near Me” button 706, which provides users with a convenient means to initiate the automatic geolocation search criteria 602C. This action prompts the system to generate a request seeking permission to access the device's current location. Upon obtaining user consent, the system engages geolocation services, automatically acquiring the precise user-specific geolocation data. An input field 710 also enables users to enter search queries (constituting automatic geolocation queries 602D). This functionality operates similarly to the location-based search criteria 602A, offering users flexibility in their search using search queries.

As previously indicated in connection with FIG. 7A, selecting the previous searches button 740 from the search menu 700 can initiate the screen dedicated to previous search criteria 602E, as depicted in FIG. 7D. In this example embodiment, the screen can include a previous search list 707. Users can quickly revisit and re-execute any of their past searches by selecting them from the previous search list 707. While the keyboard 705 is not employed as an input field in this context, it can serve various other functions and interact with other functionality. Selecting the saved searches button 750 from the search menu 700 can initiate the display of the screen dedicated to saved search criteria 602F, as depicted in FIG. 7E. In this example embodiment, the screen can include a saved search list 708, allowing users to tap on a saved search item to open a window 708A. The keyboard 705 becomes active and enables users to modify or refine the selected saved search item 708B. Once these modifications are made, users can execute the search request again by selecting either the dedicated search button 760 or hitting the “Enter” button on the keyboard 705. The saved search criteria 602F enables users to refine their saved searches quickly and efficiently according to their evolving needs, saving them time and simplifying the search process.

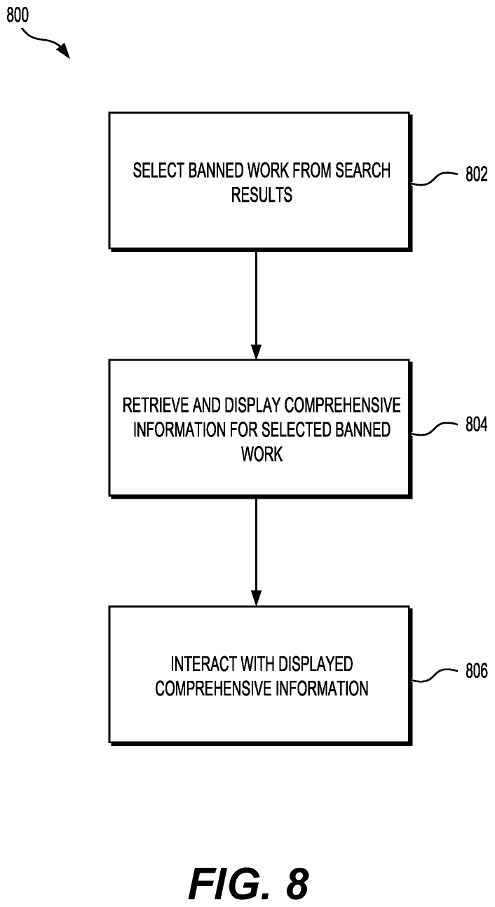

FIG. 8 illustrates the process of accessing comprehensive information about a banned work 800 selected from search results derived from the search criteria in FIG. 6. In some embodiments, after search results are generated, users can refine and customize the search results through filtering and sorting capabilities. In other embodiments, users can directly choose a particular banned work from the generated search results at step 802. Next, at step 804, the location-based system 100 can retrieve and display comprehensive information for the selected banned work, such as the title or name of the banned work, a description or summary of the banned work's content, information about the creator of the banned work, including name and biography, information about other works created by the same creator, the date when the banned work was originally published or released, the specific reasons or grounds for the work's banning or censorship, relevant historical, cultural, or social context surrounding the banned work that provides a deeper understanding of its significance, and information about legal cases or precedents related to the banning or censorship of the banned work. Additionally, the location-based system 100 can generate a list of recommended banned or non-banned works based on the selected banned work, providing users with further options. The user can interact with the displayed comprehensive information, navigate through different sections of the information, read in-depth details, and explore related resources at step 806.

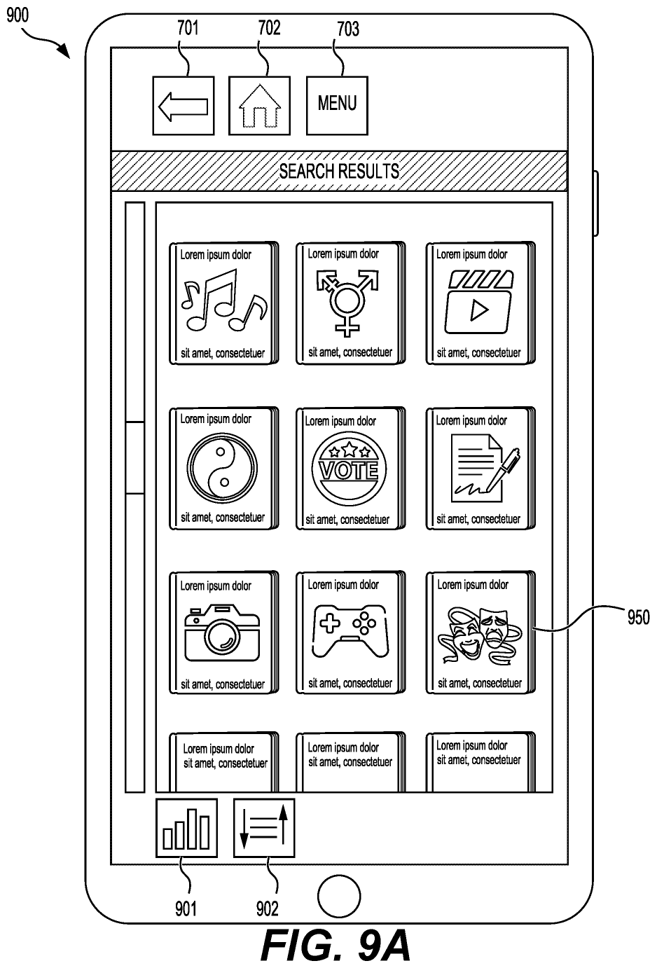

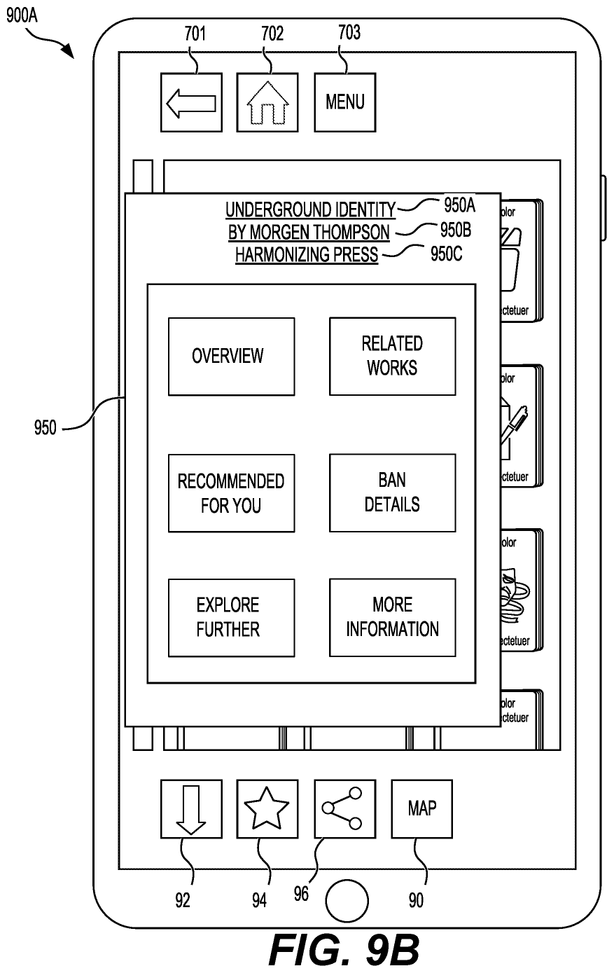

FIGS. 9A and 9B depict display screens that users may encounter when accessing the comprehensive information about a particular banned work selected from a search results list 900 according to an example embodiment. Referring to FIG. 9A, the display interface for the search results list 900 can include an aesthetically pleasing color scheme, clear typography, and well-balanced spacing between its elements. The search results list 900 can be filtered using button 901 and sorted using button 902. It can be presented in different formats, such as scrollable or paginated lists, tiles, interactive cards, images, or grid views. In various embodiments, the search results can be represented by a concise and visually appealing card-like layout. Each result card 950 can display information about the particular banned work, such as the title, a brief description, and relevant details that may pique the user's interest. Users can quickly scan through the search results list 900, which can dynamically adjust to fit the available screen space. The search results list 900 can display a predetermined number of search results per page, with pagination controls or infinite scrolling to explore additional results. In some embodiments, the result cards 950 can include interactive elements enabling users to engage in further actions beyond simply viewing the displayed information. These interactive elements can include buttons or links that allow users to perform various tasks.

When a user selects one of the result cards 950, typically by tapping or clicking on it, the location-based system 100 responds by displaying a comprehensive data view 900A of the banned work, as illustrated in FIG. 9B. Users can select the title of the banned work 950A to obtain additional information about the work's title and related details, such as genre and thematic elements, name of the creator of the banned work 950B to obtain details about the creator, such as their biography, and contributor or publisher of the banned work 950C, if applicable, to access information about other contributor or publisher works and relevant details. The comprehensive information associated with the banned works can be easily accessible and presented in various formats, such as tiles, tabs or sections, accordion menus, scrollable pages, collapse and expand, bullet points, carousels, citations and references, searchable content, multimedia, and the like. In various embodiments, users can access the comprehensive information by choosing specific details they want to view, such as an overview, related works, recommended works, ban details, and additional information. The comprehensive information allows users to not only learn about a particular banned work but also appreciate its historical, cultural, and contextual significance. It facilitates a deeper understanding of why the banned work may have been banned and its relevance in a broader context. In other embodiments, users can select a save button 92 or favorite button 94 to save or favorite a particular banned work for future reference or a share button 96 to share a particular banned work through various social media platforms.

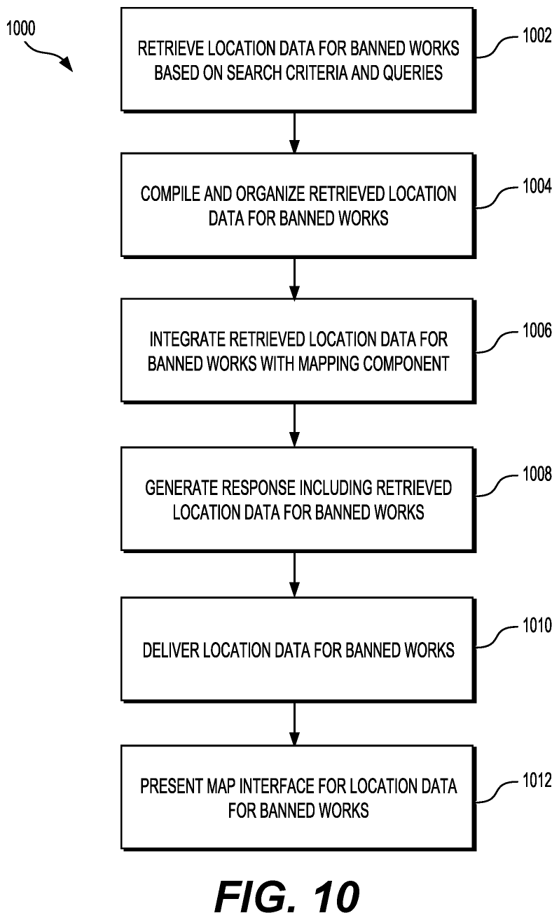

FIG. 10 illustrates the process of retrieving location data for banned works 1000, which may be implemented by the system in FIG. 1. Once the user has chosen their search criteria and entered search queries, the database module retrieves data related to the banned works and their associated locations at step 1002. After obtaining the data from the database module, the mapping module 150 integrates this information with geolocation technology. This integration enables precise mapping of the banned work data to specific geographic points based on the data from the databases 130. The mapping module 150 then incorporates geospatial coordinates and user-specific geolocation data, based on the selected search criteria, to provide search results that include information about the availability and physical location of the banned works. The information may include coordinates, addresses, location descriptions, or other data associated with specific venues, such as private libraries, public libraries, university libraries, digital libraries, online platforms, and other locations. Next, at step 1004, the location-based system 100 or mobile application 12 compiles the retrieved location data for the banned works and formats it appropriately for presentation to the user. Server-side components, such as the high-performance server 110 or the mapping module 150, integrate the retrieved location data for the banned works with the mapping component at step 1006. This integration ensures accurate representation and visualization of the locations. The server-side components or mobile application 12 can create a user-friendly response, including the retrieved location data for banned works at step 1008. It can be presented in various formats such as lists, maps, or other suitable options for convenient user viewing. The location-based system 100 sends the response back to the user through either the web-based or mobile application interface at step 1010. Next, at step 1012, the user can access and view the locations for the banned works on the map interface 520, which shows markers, labels, or other graphical elements representing coordinates, addresses, or other relevant details, tailored to their current or chosen location based on the selected search criteria. The user can interact with the map interface 520 to explore the area and navigate to the specific location where the banned work is available. In some embodiments, the location-based system 100 and mobile application 12 may include additional features for directions and navigation to assist users in arriving at the location of the selected banned work, such as route suggestions, turn-by-turn directions, estimated travel times, and other navigation aids.

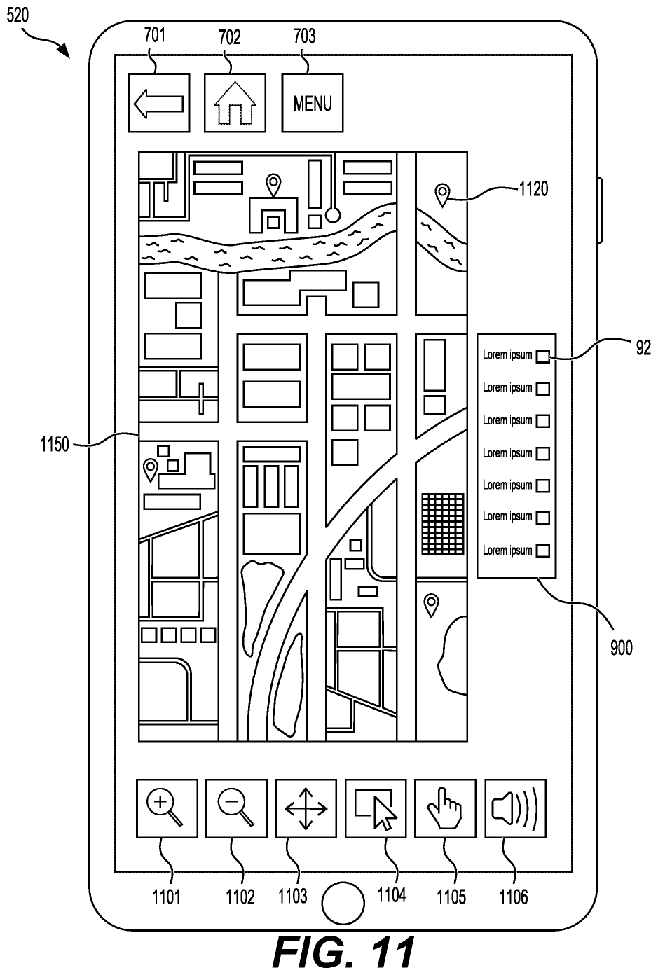

FIG. 11 illustrates a display screen of the location functionality associated with a particular banned work selected from the search results list 900. A map button 90 (illustrated in FIG. 9B) can be tapped or clicked by a user to initiate the map interface 520 for user interaction. The map interface 520 can include various elements such as maps, buttons, icons, and interactive features that enable users to interact with location information and utilize the system's features. The map 1150 provides users with an overview of the search area of where the banned work is available. A distinctive marker point 1120 on the map 1150 denotes specific locations where the banned work is located. It serves as a visual indicator to the user and is linked to the chosen banned work. The location-based system 100 might use different visual cues to distinguish between various banned works on the map 1150.

Interacting with the map 1150 is an intuitive, user-friendly experience. The intuitive map interface 520 ensures that users of various technical backgrounds can easily explore and interact with the map 1150 to access information about banned works and their associated locations. For example, users can tap on the marker point 1120, which prompts the display of location information for the selected banned work to appear. Specifically, when a user interacts with the map 1150 by selecting the marker point 1120, the map interface 520 recognizes the interaction as a request for more information about the chosen location. The map interface 520 sends a request to the database 130, explicitly querying for detailed information related to the selected location. Once the relevant information is retrieved, the map interface 520 dynamically updates to display the data. The displayed information typically includes the name or title of the selected location, the physical address of the location, which may include street name, number, city, and postal code, and, if available, the telephone number associated with the location. The information is presented in a visually accessible manner and provides users with a comprehensive overview of the selected location related to the banned work.

In various embodiments, the search results list 900 showcases the banned works matching the selected search criteria and queries. Rather than navigating back to the search menu 700 (FIG. 7A) or search results (FIG. 9A), users can select a different banned work from the search results list 900 linked to the map interface 520. Once the user selects a search item from the linked search results list 900, the map 1150 can dynamically update to focus on the specific search area corresponding to the particular selection. The location-based system 100 processes the request and the mapping module 150 responsible for mapping banned work data to the appropriate location on the map interface 520 is initiated. The mapping module 150 uses the geocoding services 503 to convert textual location information into geospatial coordinates for accurate mapping. Additionally, the mapping module 150 may integrate real-time or supplementary location data from APIs and external sources to enhance the information available to users. It uses the retrieved geospatial coordinates to accurately position the marker point 1120 on the map 1150. When the user selects the marker point 1120, the map interface 520 responds by displaying detailed information about the selected location. The map interface 520 displays the data in an accessible and user-friendly format, allowing users to access information with ease.

To access comprehensive information for a different banned work directly from the map interface 520, users can select button 92 which can be positioned next to the corresponding search item listed in the search results list 900, triggering the display of the comprehensive information in the comprehensive data view 900A (FIG. 9B) or other formats or interfaces, such as a pop-up window. The selection of button 92 serves as a trigger or input signal from the user indicating their intent to view comprehensive information about the selected banned work. In response to the user's action, the location-based system 100 processes the request and retrieves the comprehensive information associated with the selected banned work according to process 800 of FIG. 8. Once the comprehensive information is retrieved, it is presented to the user for review and exploration.

In other embodiments, the map interface 520 offers a comprehensive set of interactive functionalities, designed to enrich the user's experience and provide deeper insights into the location of the banned works in relation to their surroundings. Users can utilize a zoom-in button 1101 to zoom in on specific areas of the map 1150, providing a more detailed view. This is particularly useful for examining fine details or focusing on a particular location associated with the banned work. In contrast, the zoom-out button 1102 enables users to broaden their view, displaying a larger geographical area. This is particularly helpful for gaining a perspective on the overall distribution of banned works. The panning button 1103 allows users to shift the map 1150 in different directions, facilitating flexible exploration of the area of interest. Users can easily navigate the map 1150 to view various locations. The select button 1104 enables users to interact with specific elements on the map 1150. They can choose a banned work, initiating actions like obtaining comprehensive information or location information associated with the banned work. The drag button 1105 permits users to move the map 1150 around, making it convenient to focus on specific parts of the map 1150 for a detailed examination. This exploration aids in understanding the location of banned works in relation to nearby landmarks, streets, subways, railways, or bus stops. The map interface 520 can also provide supplementary options, such as route planning and directions using button 1106. The location-based system 100 can provide a route with step-by-step instructions for navigating to the chosen location. These features ensure users have a rich and informative experience using the location-based system 100.

The location-based system 100 can provide users with a centralized location for accessing various resources, making it easier to explore information, stay updated on news, and enjoy podcasts related to banned works, irrespective of a particular banned work. It enhances the user experience and the educational value of the system. In an example embodiment, the location-based system 100 can include a podcasts section on the main or home screen of the search application or navigation bar, separate from the search results. Users who select this section are presented with a list of podcasts related to banned works and topics. The location-based system 100 can subscribe to RSS feeds and actively check for updates in the feeds to keep its podcast content up to date. Users can browse through a podcast library, which includes a collection of podcasts linked to various banned works. These podcasts can provide insights, discussions, or additional context about censorship and the effects on different forms of art and culture. Users can listen to the podcasts directly from the location-based system 100 or download episodes for offline listening. Users can search for specific podcasts or use filters to find content of interest within the podcasts section. Filters may include categories, themes, popularity, or hosts. In addition to the podcasts section, there can be a dedicated news section on the main or home screen. This section aggregates news articles, blog posts, or updates on banned works and censorship. The location-based system 100 can parse the news feeds and retrieve recent articles or updates. The news feeds can be acquired through RSS or Atom feeds from trusted news sources, including established news websites, blogs, or even official statements related to banned works. Similar to podcasts, the system can subscribe to the news feeds relevant to banned works, censorship, and related topics. Users can search for specific news articles or use filters to sort news by topics, relevance, publication date, or other criteria. Further, there can be a favorites section on the main or home screen that allows users to favorite their favorite websites, applications, or content related to banned works. This can serve as a personal collection of resources. Users can add their favorite links to booksellers, libraries, educational websites, or any other sources that provide information or access to banned works. Users can organize their favorite links into categories and sync them across devices if they are using the system on multiple platforms.

The location-based platform and methodologies for delivering location-specific and targeted search results for banned works in the present disclosure significantly enhance accessibility to information about banned works. Users are easily able to locate and explore the banned works, enabling a deeper understanding of their content, historical context, and the reasons behind their censorship. The location-based system 100 is accessible to users with varying levels of technical expertise. This simplicity encourages users from all backgrounds to engage with the location-based system 100, making it a useful tool for those interested in censored or banned works. The location-based system 100 leverages real-time geolocation data, providing users with up-to-date and location-specific information about banned works. This ensures users receive timely and pertinent details, enriching their experience and understanding. Moreover, the location-based system 100 is not limited to mere location-based searches; it offers comprehensive information about banned works, including titles, creators, related works, reasons for bans, historical context, authoritative and administrative legal decisions, and more. Users benefit from this depth of information, which is invaluable for those seeking to explore the censored and banned works. Additionally, users can tailor their searches, using search queries and filter categories to meet their specific preferences and requirements. This adaptability ensures that users can efficiently retrieve the information they seek, enhancing their overall experience. Efficiency simplifies the process of accessing banned works, eliminating the need for users to search through a multitude of sources or libraries. The result is a significant reduction in the time and effort to obtain relevant information, which enhances the user experience and encourages a more comprehensive exploration of banned works. Additionally, the location-based system 100 contextualizes banned works, granting users an unprecedented insight into the interplay between regulations and restrictions governing banned content, encompassing material considered inappropriate, sensitive, or illegal and their alignment with specific jurisdictions (e.g., counties, cities, districts). This geographic insight is a distinctive element of the location-based system 100, enriching users' understanding of censorship and its relationship to specific jurisdictions. Furthermore, the location-based system 100 provides authoritative and administrative legal decisions and a range of other information related to banned works. This information holds educational and legal value, serving the needs of researchers, educators, and legal professionals in their work. The present teachings not only expand access to information but also encourage user engagement, deepening the understanding of banned works and the legal decisions surrounding them.

The preceding description is merely illustrative in nature and is in no way intended to limit the disclosure, its application, architecture, or uses. As used herein, the phrase at least one of A, B, and C should be construed to mean a logical A or B or C, using a non-exclusive logical “or.” It should be understood that the various steps within a method may be executed in different order without altering the principles of the present disclosure. Disclosure of ranges includes disclosure of all ranges and subdivided ranges within the entire range.

The headings such as “Background” and “Summary” and sub-headings used herein are intended only for general organization of topics within the present disclosure and are not intended to limit the disclosure of the technology or any aspect thereof. The recitation of multiple embodiments having stated features is not intended to exclude other embodiments having additional features, or other embodiments incorporating different combinations of the stated features.

As used herein, the terms “comprise” and “include” and their variants are intended to be non-limiting, such that recitation of items in succession or a list is not to the exclusion of other like items that may also be useful in the devices and methods of this technology. Similarly, the terms “can” and “may” and their variants are intended to be non-limiting, such that recitation that an embodiment can or may comprise certain elements or features does not exclude other embodiments of the present technology that do not contain those elements or features.

The broad teachings of the present disclosure can be implemented in a variety of forms. Therefore, while this disclosure includes particular examples, the true scope of the disclosure should not be so limited since other modifications will become apparent to the skilled practitioner upon a study of the specification and the following claims. Reference herein to one aspect, or various aspects means that a particular feature, structure, or characteristic described in connection with an embodiment or particular system is included in at least one embodiment or aspect. The appearances of the phrase “in one aspect” or variations thereof are not necessarily referring to the same aspect or embodiment. It should be also understood that the various method steps discussed herein do not have to be carried out in the same order as depicted, and not each method step is required in each aspect or embodiment.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations should not be regarded as a departure from the disclosure, and all such modifications are intended to be included within the scope of the disclosure.

The claims should not be read as limited to the described order or elements unless stated otherwise. It should be understood that various changes in form and detail may be made by one of ordinary skill in the art without departing from the spirit and scope of the claims. All implementations that come within the spirit and scope of the claims and equivalents thereto are claimed.

What is claimed is:

1. A location-based system for searching and accessing banned works, comprising:
a client device utilizing a web-based interface to initiate search requests for banned works when predetermined location-based search criteria or automatic geolocation search criteria are selected;
a high-performance server hosting a search engine module, the search engine module operable to process the search requests received from the client device and generate matching search results based on the predetermined search criteria;
a database module operable to access one or more databases containing information pertaining to banned works and their associated locations, the database module facilitating data retrieval for the search engine module;
a mapping module operable to flexibly integrate with the location-based system and map banned work data to a plurality of data points from the one or more databases based on geospatial coordinates for the location-based search criteria or user-specific geolocation data for the automatic geolocation search criteria; and
a network infrastructure operable to facilitate connectivity between system components, including the client device, high-performance server, database module, and mapping module, to enable transmission of data,
wherein the location-based system enables users to identify and access location-specific banned work results, including comprehensive information associated with the banned works and details regarding their associated locations, through the web-based interface.

2. The system according to claim 1, wherein the banned works include books, literature, performing arts, visual arts, video games, symbols, educational courses, products, or services.

3. The system according to claim 1, wherein the comprehensive information associated with the banned works includes titles, descriptions, creators, biographies of creators, additional creator works, recommended works, publication dates, grounds for banning, historical and cultural context, or authoritative and administrative legal decisions.

4. The system according to claim 1, wherein the search criteria encompasses search queries aligned with user preferences to enhance or further define the search results.

5. The system according to claim 1, wherein the web-based interface is a web browser or other suitable client software on a computer.

6. The system according to claim 1, wherein the one or more databases are private and/or public.

7. The system according to claim 1, wherein the database module comprises interconnected databases operable to provide the comprehensive information associated with the banned works from various sources and periodically updates the interconnected databases with current banned works and remove outdated or lifted banned works.

8. The system according to claim 1, wherein the mapping module comprises an interactive map interface on the web-based interface having interactive features operable to select and search the banned works and displaying locations and calculated distances of the banned works selected from the search results.

9. The system according to claim 1, wherein the network infrastructure comprises an internet, cellular network, Wi-Fi, ethernet, fiber optics, or satellite network.

10. The system according to claim 1, wherein the web-based interface provides options to sort and filter the search results based on user preferences.

11. A location-based system for searching and accessing banned works, comprising:
a client device equipped with a mobile application operable to initiate search requests for banned works when predetermined location-based search criteria or automatic geolocation search criteria are selected;
a search engine module, integrated within the mobile application, operable to process search requests and generate matching search results based on the predetermined search criteria;
a database module operable to access one or more databases containing information pertaining to banned works and their associated locations and facilitate data retrieval for the search engine module;
a mapping module, integrated within the mobile application, operable to map banned work data to a plurality of data points from the one or more databases based on geospatial coordinates for the location-based search criteria or user-specific geolocation data for the automatic geolocation search; and
a network infrastructure operable to facilitate connectivity between the client device and database module to enable transmission of data,
wherein the location-based system enables users to identify and access location-specific banned work results, including comprehensive information associated with the banned works and details regarding their associated locations, through the mobile application.

12. The system according to claim 11, wherein the search criteria encompasses search queries aligned with a user's specific preferences to enhance or further define the search results.

13. The system according to claim 11, wherein the client device is a mobile device, smartphone, or computer connected to an internet, and comprises keyboard navigation support, alternative text for images, and/or compatibility with screen readers to accommodate users with varying disabilities.

14. The system according to claim 11, wherein the search engine module comprises offline functionality operable to store and process data locally on the client device when an internet connection is unavailable.

15. The system according to claim 11, wherein the search engine module utilizes natural language processing to enhance search accuracy and relevance.

16. The system according to claim 11, wherein the database module comprises interconnected databases operable to provide the comprehensive information associated with the banned works from various public and/or private sources and is programmed to routinely update the interconnected databases with current banned works while removing outdated or lifted banned works.

17. The system according to claim 11, wherein the mobile application provides users with additional functionalities to display locations of the banned works on interactive maps, calculate distances, and provide navigation to the locations of the banned works;
and options to sort and filter the search results based on user preferences.

18. The system according to claim 11, further comprises security means operable to safeguard integrity and privacy of user data and banned work data and prevent unauthorized access and manipulation of the database module.

19. The system according to claim 11, further comprises a notification module operable to provide users with real-time alerts and updates, inform users of changes in banned work availability, and notify users of any updates or alterations in ban status of previously saved searches.

20. A location-based method for searching and accessing banned works, comprising the steps of:
enabling user interaction with a location-based system through a client device operable to initiate search requests for banned works when predetermined location-based search criteria or automatic geolocation search criteria are selected and/or search queries are entered;
processing search requests to generate matching search results based on the predetermined search criteria within a search engine module;
accessing one or more databases containing information pertaining to banned works and their associated locations within a database module operable to facilitate data retrieval for the search engine module, the database module comprises interconnected databases, including private and/or public sources;
mapping banned work data to a plurality of data points from the one or more databases based on geospatial coordinates for the location-based search criteria or user-specific geolocation data for the automatic geolocation search criteria; and
delivering users location-specific banned work results, including comprehensive information associated with the banned works and details regarding their associated locations, tailored to a users' real-time geographical context.
